(19) United States
(12) Patent Application Publication
(10) Pub. No.: US 2011/0184784 A1
(43) Pub. Date: Jul. 28, 2011

(54) Tracking Carbon Footprints

(75) Inventors: Richard W. Rudow, Mesa, AZ (US); Robert C. Wold, Phoenix, AZ (US); Thomas C. Joseph, Fremont, CA (US); Daniel J. Wallace, Louisville, CO (US); Andrei T. Link, Redwood (NZ); Lawrence J. Fox, Scottsdale, AZ (US); James M. Janky, Los Altos, CA (US)

(73) Assignee: TRIMBLE NAVIGATION LIMITED, Sunnyvale, CA (US)

(21) Appl. No.: 13/014,074

(22) Filed: Jan. 26, 2011

Related U.S. Application Data
(60) Provisional application No. 61/298,779, filed on Jan. 27, 2010.

(51) Int. Cl. G06F 7/00; G06Q 10/00

(52) U.S. Cl. 705/7.38; 701/32; 705/1.1

(57) ABSTRACT

Novel solutions to the challenges of obtaining accurate information about a user's or an organization's carbon footprint. In some cases, these solutions can obtain and/provide feedback about a user's carbon output based on the user's habits and choices. Some solutions are designed to supply services to individuals as well as commercial ventures and for a variety of vehicle fleets, including without limitation construction equipment. In different aspects, systems in accordance with various embodiments enable a variety of types of users to create their own carbon emission generation profile based on vehicle type; track, estimate, and store their emissions in a database; analyze their results and performance, using established methods and metrics and/or automatically update all operating parameters of interest.

### CROSS-REFERENCES TO RELATED APPLICATIONS

The present disclosure may be related to the following commonly assigned applications/patents:

This application claims the benefit, under 35 U.S.C. §119(e), of provisional U.S. Patent Application No. 61/298,779, titled “Tracking Carbon Footprints” and filed Jan. 27, 2010 by Rich Rudow et al., the entire disclosure of which is incorporated herein by reference for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to tracking carbon output and more particularly, to tools and techniques for tracking a user's carbon footprint.

### BACKGROUND

Personal awareness of one's carbon impact on the environment is increasing as news of Global Climate Change permeates the news media. Many people would like to adjust their behavior to minimize their impact on atmospheric carbon levels (i.e., their carbon footprint). But the opportunity for acquiring accurate and timely knowledge about one's carbon impact is quite limited.

Similarly, many organizations would like to have better tools for monitoring atmospheric carbon output. For example, some companies operate under regulatory conditions that either require them to monitor and/or control atmospheric carbon output or that provide incentives for doing so. Such incentives can include the opportunity to trade carbon credits (if an organization operates under a particular threshold), additional taxes and/or fines (if an operation operates above a particular threshold), and/or the like. Further, because atmospheric carbon output generally correlates with consumption of expensive fossil fuels, an organization may be able to realize additional profit through monitoring overall carbon output and modifying behavior accordingly.

Often, an organization will maintain a fleet of vehicles (which may include typical light duty vehicles, heavy duty or construction vehicles, or both), and the ability to monitor atmospheric carbon output across the fleet could enable the organization to make fleet-wide decisions to improve organizational efficiency. An individual user might similarly have a fleet (which might merely comprise two or three family vehicles) and could similarly benefit from such information.

For both individual users and organizations, carbon output sources can include both mobile sources (e.g., vehicles) and non-mobile sources (e.g., building utility usage). Both types of users, therefore, could benefit from a solution that enabled tracking of carbon output from both mobile and non-mobile sources.

### BRIEF SUMMARY

A set of embodiments provides comprehensive solutions to the challenges of obtaining accurate information about a user's or an organization's carbon footprint. In some cases, these solutions can obtain and/provide feedback about a user's carbon output based on the user's habits and choices, and/or feedback about performance results in relation to those of other comparable users, in a simple and easy to use system.

Moreover, in one aspect, certain embodiments are designed to supply services to individuals as well as commercial ventures and for a variety of vehicle fleets, including construction equipment. In different aspects, systems in accordance with various embodiments enable a variety of types of users to create their own carbon emission generation profile based on vehicle type; track, estimate, and store their emissions in a database; analyze their results and performance, using established methods and metrics; automatically update all operating parameters of interest; and/or find relevant information about carbon emissions and climate-related effects.

Particular embodiments include a mobile client, which might reside in a wireless device, such as a wireless phone, personal digital assistant, handheld navigation device and/or the like. In other embodiments, the mobile client might be integrated within any of the various electronic systems in a vehicle, such as an onboard diagnostic computer, navigation system, and/or the like. In either case, the mobile client might interface with a server-based system. Together, the mobile client and the server-based system can operate to gather operating data about one or more vehicles, to analyze the data to produce conclusions about atmospheric carbon output, and/or to provide output to users (e.g., through the mobile client, through a web page or other interface, etc.) about such carbon output. In this way, the system can provide a user with feedback (including without limitation real-time or near-real-time) feedback about the user's activities, which can enable the user to modify his behavior to reduce carbon output if desired and/or to compare that user's carbon output with baseline data.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical and/or tangible computer readable media (such as, to name but a few examples, optical media, magnetic media, and/or the like).

Merely by way of example, one set of embodiments provides methods of determining vehicle performance statistics, including without limitation a vehicle's carbon emissions. One such method can comprise capturing, with a computer system, an identity of the vehicle. In some embodiments, the method further comprises identifying, with the computer system, a first position of the vehicle at a first time, and/or identifying, with the computer system, a second position of the vehicle at a second time. In one aspect, the second time might be subsequent to the first time.

The method might further comprise ascertaining one or more operating parameters of the vehicle. In some cases, the method includes identifying, based at least in part on the identified first position at the first time, the identified second position at the second time, and/or the one or more operating parameters of the vehicle, a vehicle activity over a first period. In certain embodiments, the method comprises estimating a carbon output rate for the first period, based (in some cases) at least in part on the identity of the vehicle and/or the vehicle activity over the first period. The method might further comprise generating a carbon emission value for the vehicle, based at least in part on the first carbon output rate.

Other embodiments provide methods of determining performance statistics (e.g., carbon emissions) for a plurality of vehicles, such as a fleet of vehicles. An exemplary method might comprise, for each of a plurality of vehicles in a fleet of construction vehicles, performing the following operations: capturing, with a computer system, an identity of the vehicle; identifying a vehicle activity over a first period; estimating a carbon output rate for the first period, e.g., based at least in part on the identity of the vehicle and/or the vehicle activity over the first period; and generating a carbon emission value for the vehicle, based at least in part on the first carbon output rate. In one aspect, a method such as the method described above can be used to generate a carbon emission value for each vehicle. In some embodiments, the method might further comprise consolidating the carbon emission values generated for each of the plurality of vehicles, to obtain a fleet carbon emission value for the fleet of construction vehicles.

Another set of embodiments provides systems. An exemplary system might comprise a computer system comprising one or more processors, and a computer readable medium in communication with the one or more processors. In an aspect, the computer readable medium can have encoded thereon a set of instructions executable by the computer system to perform one or more operations.

In one embodiment, the set of instructions comprises instructions for capturing, with a computer system, an identity of a vehicle. The set of instructions might also comprise instructions for identifying, with the computer system, a first position of the vehicle at a first time and/or instructions for identifying, with the computer system, a second position of the vehicle at a second time, wherein the second time is subsequent to the first time. The set of instructions can further include instructions for ascertaining one or more operating parameters of the vehicle and/or instructions for identifying a vehicle activity over a first period. In an aspect of a particular embodiment, this identification of vehicle activity can be based at least in part on the identified first position at the first time, the identified second position at the second time, and/or the one or more operating parameters of the vehicle. There might also be further instructions for estimating a carbon output rate for the first period, based at least in part, in some cases, on the identity of the vehicle and the vehicle activity over the first period, and/or instructions for generating a carbon emission value for the vehicle, perhaps based at least in part on the first carbon output rate.

In accordance with another embodiment, the set of instructions might include, for each of a plurality of vehicles in a fleet of construction vehicles, instructions for capturing, with a computer system, an identity of the vehicle; instructions for identifying a vehicle activity over a first period; instructions for estimating a carbon output rate for the first period, perhaps based at least in part on the identity of the vehicle and the vehicle activity over the first period; and/or instructions for generating a carbon emission value for the vehicle, based at least in part on the first carbon output rate. The set of instructions might further comprise instructions for consolidating the carbon emission values generated for each of the plurality of vehicles, to obtain a fleet carbon emission value for the fleet of construction vehicles.

In some embodiments, the computer system might be a wireless handheld device. In other embodiments, the computer system might be a tracking server, and/or the system might further comprise a mobile device, such as a wireless handheld device, a vehicle data system, and/or the like. The mobile device might be configured to collect vehicle operating parameters and/or transmit those parameters to be received by the tracking server. The mobile device might also be configured to provide a user interface to allow interaction between a user and the tracking server. In yet other embodiments, the system might further comprise a position determination system (e.g., a global navigation satellite system receiver) configured to determine positions of the vehicle system at associated times.

Further embodiments provide mobile devices, including without limitation mobile devices that can provide information to users about carbon emissions. An exemplary mobile device might comprise one or more processors. The mobile device might further comprise a first interface, in communication with the one or more processors, for receiving position information. Examples of such interfaces might include, but are not limited to, a global network satellite system receiver, a wired or wireless interface for communicating with a separate device comprising a global network satellite system receiver, and/or the like. The mobile device, in some embodiments, might also include a second interface, in communication with the one or more processors, for communicating via a communication network. Such interfaces can include, without limitation, wireless interfaces such as cellular radios, WiFi radios, etc., and wired interfaces, such as Ethernet interfaces, universal serial bus interfaces, and/or the like.

In some embodiments, the mobile device further comprises a computer readable storage medium in communication with the one or more processors. In an aspect, the computer readable storage medium can have encoded thereon a set of instructions executable by the mobile device to perform one or more operations. Merely by way of example, the set of instructions might include instructions for providing a user interface to allow interaction between a user and the mobile device. The set of instructions can further comprise instructions for identifying a vehicle for which carbon output is to be tracked. In some cases, there can be instructions for receiving position information via the first interface and/or instructions for identifying, based at least in part on the position information, a first position of the mobile device at a first time and a second position of the mobile device at a second time.

The mobile device might also include instructions for transmitting, via the second interface, an identification of the vehicle, an identification of the first position and an identification of the second position. In some cases, the instructions further comprise instructions for receiving, via the second interface, information about carbon emissions of the vehicle over a period of time defined by the first time and the second time, and/or instructions for providing, via the user interface, feedback for the user, based on the information about carbon emissions of the vehicle over the period of time.

Another set of embodiments provides an apparatus. An exemplary apparatus for determining one or more performance statistics for a vehicle might comprise a computer readable medium having encoded thereon a set of instructions executable by one or more computers to perform one or more operations. The set of instructions might include instructions similar to those described above.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIGS. 1A and 1B are block diagrams illustrating a system for tracking carbon output, in accordance with various embodiments.

FIGS. 2A and 2B are block diagrams illustrating a set of mobile components within a system for tracking carbon output, in accordance with various embodiments.

FIG. 3 is a generalized block diagram illustrating functional components of a user interface of a mobile device for tracking carbon output, in accordance with various embodiments.

FIGS. 4A and 4B are process flow diagrams illustrating methods of tracking carbon output, in accordance with various embodiments.

FIG. 5 is a process flow diagram illustrating a method of registering a vehicle in a carbon tracking system, in accordance with various embodiments.

FIG. 6 is a process flow diagram illustrating a method of tracking carbon output, in accordance with various embodiments.

FIG. 7 is a process flow diagram illustrating a method of identifying a mode of transportation using an inference manager, in accordance with various embodiments.

FIG. 8 is a process flow diagram illustrating a detailed method of identifying a vehicle using an inference manager, in accordance with various embodiments.

FIGS. 9-12 illustrate exemplary decision matrices that may be used by an inference manager to identify a mode of transportation, in accordance with various embodiments.

FIG. 13 is a process flow diagram illustrating a method of tracking carbon output based on vehicular operational data, in accordance with various embodiments.

FIG. 14 is a process flow diagram illustrating a method of tracking carbon output for a project, in accordance with various embodiments.

FIG. 15 is a generalized schematic diagram illustrating a computer system, in accordance with various embodiments.

FIG. 16 is a block diagram illustrating a networked system, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

A set of embodiments provides comprehensive solutions to the challenges of obtaining accurate information about a user's or an organization's carbon footprint. In some cases, these solutions can obtain and/provide feedback about a user's carbon output based on the user's habits and choices, and/or feedback about performance results in relation to those of other comparable users, in a simple and easy to use system. Merely by way of example, the tools provided by various embodiments can be used to track a user's (and/or an organizations) carbon output, based upon the vehicles the user (or organization) uses for transport, and/or the user's driving habits. This data can be compared with baseline data to allow the user (or organization) to understand how different vehicle selection (and/or driving behavior) can positively (or negatively) effect that user's (or organization's) atmospheric carbon output. As used herein, the term, “vehicle” should be interpreted broadly to include not only any mobile source atmospheric carbon, but any other means of locomotion that may have a negligible (or even negative) impact on atmospheric carbon, such as bicycle riding, walking, and/or the like.

Moreover, in one aspect, certain embodiments are designed to supply services to individuals as well as commercial ventures and for a variety of vehicle fleets, including construction equipment. In different aspects, systems in accordance with various embodiments enable a variety of types of users to 1) create their own carbon emission generation profile based on vehicle type; 2) track, estimate, and store their emissions in a database; 3) analyze their results and performance, using established methods and metrics; 4) automatically update all operating parameters of interest; and/or 5) find relevant information about carbon emissions and climate-related effects. In this way, tools provided by various embodiments can help to reduce user ignorance and help users to make more informed decisions about behavior (e.g., transportation selection, utility consumption, etc.).

Particular embodiments include a mobile client, which might interface with a server-based system. Together, the mobile client and the server-based system can operate to gather operating data about one or more vehicles, to analyze the data to produce conclusions about atmospheric carbon output, and/or to provide output to users (e.g., through the mobile client, through a web page or other interface, etc.) about such carbon output. In this way, the system can provide a user with feedback (including without limitation real-time or near-real-time) feedback about the user's activities, which can enable the user to modify his behavior to reduce carbon output if desired and/or to compare that user's carbon output with baseline data.

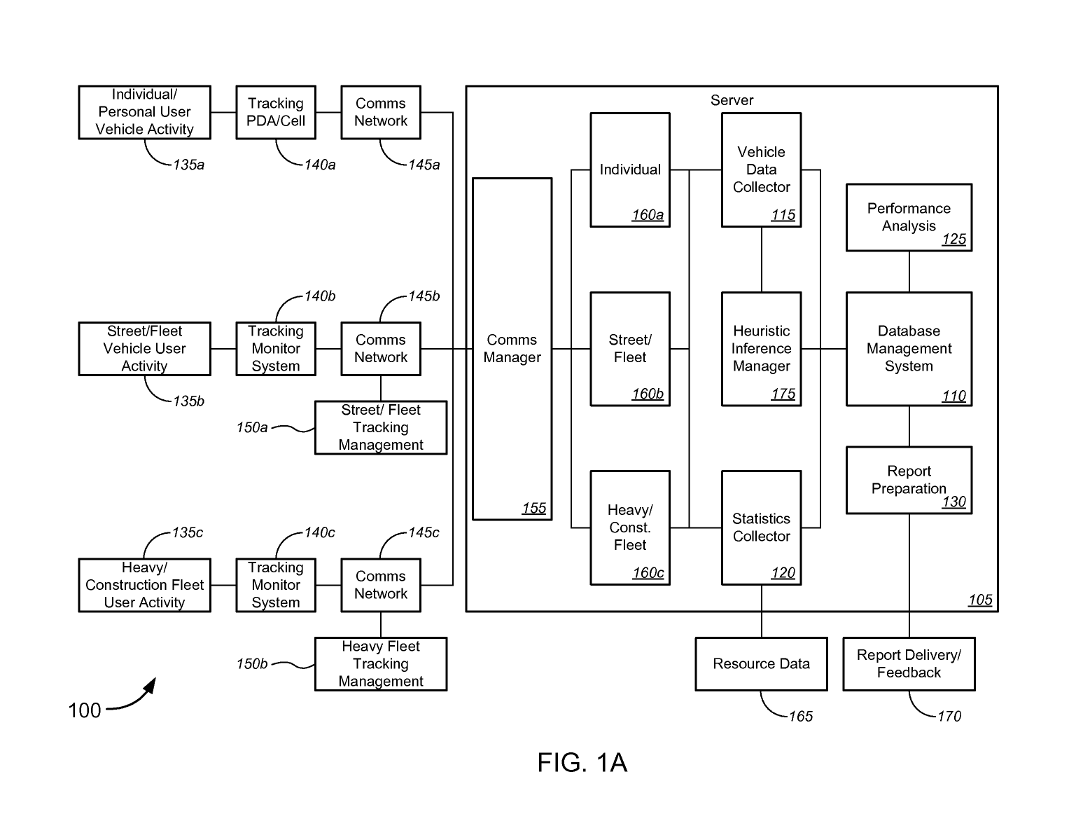

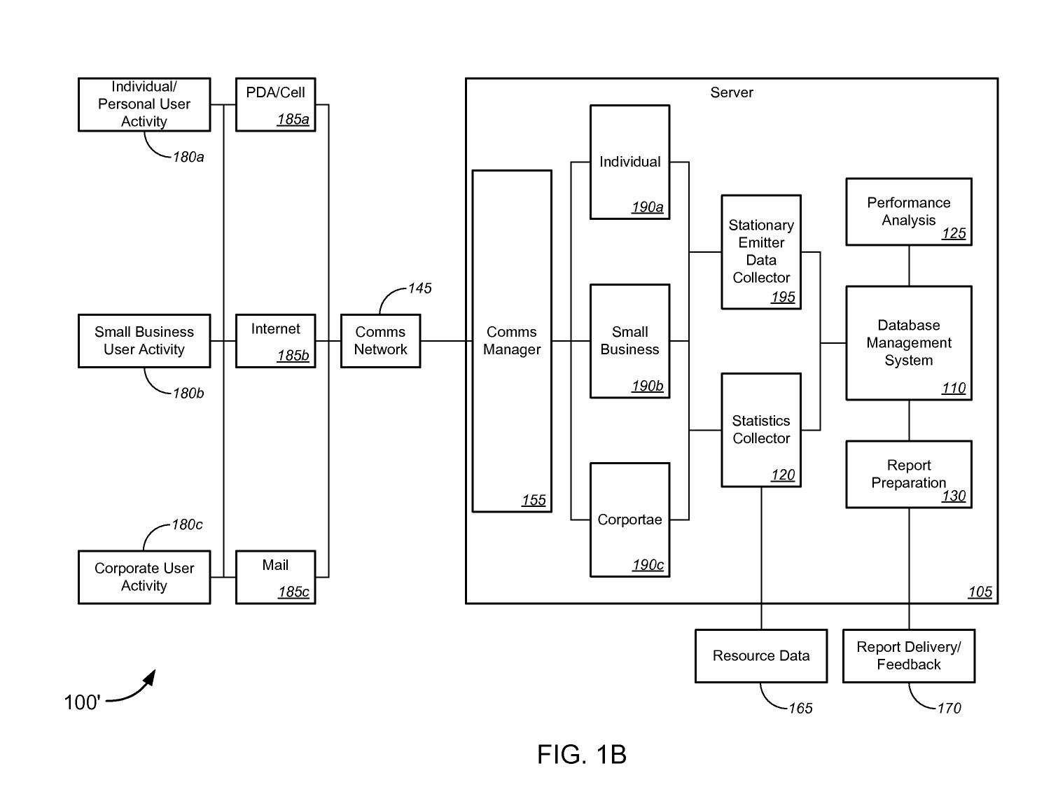

Merely by way of example, FIG. 1 illustrates a system 100 that can be used to track mobile carbon output (i.e., atmospheric carbon output from mobile sources, such as vehicles) for users and/or organizations. The system 100 includes a carbon tracking server 105. (While, for ease of illustration, the server 105 is illustrated, and described herein, as a single, monolithic computer system, it should be appreciated that the functions ascribed to the server 105 can be subdivided among multiple computer systems as appropriate, and that the term “server,” as used herein, should be interpreted to include both a single computer system and a set of multiple computer systems operating in concert.)

In the illustrated embodiment, the server 105 includes a database management system 110, which manages a database (which is not illustrated on FIG. 1A but can comprise any data storage arrangement that can be used to store data, including without limitation, one or more a relational databases, flat-file databases, file systems, and/or the like). The database stores information employed by and/or generated by various methods and procedures described herein. Such information can include, without limitation, operating data received from a mobile client, performance data for a variety of vehicles, vehicular pattern behavior for use by an inference manager, baseline carbon output data for a variety of vehicles and/or activities, and/or the like. Merely by way of example, in some embodiments, the database stores a plurality of data sets (which might be tables, records, etc.), and each data set can comprise a plurality of estimated performance statistics (e.g., under different operating conditions) for a particular vehicle. The database (or another database) might also store different types of information.

In one aspect, the database 110, or the server 105 more generally, can act as an aggregator of carbon emissions data (and other vehicle performance data) for a large number of individuals. The server 105, for example, might be configured to aggregate individuals' data sets into groups by various demographic profiles and/or other associations, to filter data sets by various criteria, and/or to provide aggregated reports, e.g., to users, corporate auditors, third parties, regulatory agencies, etc. In this way, the database 110 can serve as a rich source of data about individual behaviors and their individual (and/or collective) effect on carbon output. In this way, the database 110 can help to inform individual decision making, corporate decision making, public policy, and the like.

The server 105 also includes a vehicle data collector 115, which is responsible for receiving data from various mobile clients about particular vehicle operating parameters and/or activities and routing it to appropriate functional blocks (e.g., the database management system 110), and/or a statistics collector, which functions to collect statistics (including baseline statistics) about user/vehicle behavior. The vehicle data collector 115 and the statistics collector 120 are in communication with the database management system 110, which can interface with these collectors 115, 120 to receive data for storage in the database.

The database management system 110 may also be in communication with a performance analysis module 125 and/or a report preparation module 130. The performance analysis module 125 can analyze the carbon output performance of a particular user and/or vehicle based on data from the database, and/or to interface with the database management system 110 to store the results of performance analysis in the database. The report preparation module 130 can be used to prepare reports for users (which can include actual users of the vehicles, but also fleet managers, corporate auditors, regulatory agencies, or others), based, in some cases, on data collected by the collectors 115, 120 and/or generated by the performance analysis module 125. Such reports can include aggregated reports that group and/or filter individual data sets, as described above.

The operation of certain embodiments of the system 100 is described in further detail below, but generally, the server 105 functions to track carbon output based on a variety of vehicle activities. Such activities can include an individual user's vehicle activity 135a, the activities 135b of a fleet of one or more street vehicles (e.g., light-duty vehicles, delivery and/or service vehicles, etc.), and/or the activities 135c of a fleet of one or more construction/heavy duty vehicles (e.g., heavy-duty trucks, tractors and other construction equipment, etc.). In a particular aspect, as described in further detail below, the system 100 can be used to track a project carbon emission value (“CEV”) and/or compare that project CEV with a target project CEV, as well as to suggest reallocation of vehicular resources to more closely align the project CEV with the target project CEV.

In a set of embodiments, the vehicular activities of individual users and/or fleets of vehicles, including without limitation street fleets and/or construction fleets 135a, 135b, 135c, are tracked by a mobile tracking system. In the case of an individual user's vehicle activity 135a, the activity might be tracked by a tracking system that employs an application on a mobile device, such as a PDA, GPS receiver, and/or wireless phone 140a, which may be, but need not necessarily be, integrated with (and/or in communication with) a vehicle diagnostic system, such as version two of the standard on-board diagnostic system (“OBDII”) that is common in vehicles sold in the United States and other countries, with a vehicle navigation system, and/or with other electronic systems available in a variety of vehicles. In the case of street fleets or construction fleets, vehicles often have diagnostic, tracking and/or telemetry systems installed (including without limitation various components of the GeoManager™ line of products commercially available from Trimble Navigation Ltd.™), and the activities 135b, 135c of vehicles in such fleets may be tracked by such systems (which are referred to herein as “tracking monitor systems”) 140a, 140b, respectively. (It should be appreciated, of course, that an individual user's vehicle might include such a tracking monitor system, which can be used to gather data about vehicle activities, and/or that the activities of fleet vehicles might be tracked through the use of a PDA, wireless phone, etc. without the use of a tracking monitor system). The term “mobile device” is used herein to refer to any wireless device, mobile tracking system, tracking monitor system, mobile tracking device, or other device, whether incorporated within a vehicle (e.g., as part of the vehicle's electronic systems), in communication with the vehicle (e.g., via a Bluetooth link, wired link, etc.) or separate from the vehicle (e.g., carried by the user in or around the vehicle), that is used to provide an interface for the operator of a vehicle and/or to collect operating parameters at or near the vehicle.

The mobile tracking system (whether based on a wireless phone application, a specialized mobile tracking device, a tracking monitor system, or any other type of mobile device) interfaces with a communication network 145, which provides communication with the server 105. The communication network 145 can include any of a variety of public or private communication networks (including without limitation public wireless networks—such as cellular networks—an/or public wired networks, private wireless/and or wired networks, the Internet, and/or the like) and/or combinations of various networks. It should be appreciated, of course, that the types of networks employed might depend, in some cases, on the type of mobile tracking system implemented. Merely by way of example, if the mobile tracking system is implemented as an application on a wireless phone 140a, a public wireless (cellular) network might provide the interface between the mobile tracking system and the server 105 (or an intermediate network that provides communication with the server 105). In contrast, if the mobile tracking system depends on a tracking monitor system 140b, 140c, a private wireless network (e.g., a wireless wide-area network (“WWAN”)) might provide the interface between the mobile tracking system and the server 105 (or intermediate network). Hence, different types of networks 145a, 145b, 145c might (or might not) be employed to provide communications with different types of mobile tracking systems. In any event, the nature of the network topology that provides communication between a mobile tracking system and the server 105 is discretionary, and that embodiments are not limited to any particular networking technology, so long as communication can be established between the mobile tracking systems and the server 105.

In some cases, if a tracking monitor system is implemented as part of the mobile tracking system, a fleet tracking management system 150 might be used (perhaps in conjunction with a private wireless network, public wireless network, etc. to provide communication between the tracking monitor system 140b, 140c and the server 105). Once again, examples of such fleet tracking management system include, without limitation, components of the GeoManager™ product line described above.

In the illustrated embodiment, the server 105 includes a communication manager 155, which communicates with various communication networks 145 and provides an interface between various mobile tracking systems and the server 105. The communication manager 155 receives data about various vehicle activities, including individual user activity data 160a, street fleet vehicle activity data 160b, and/or heavy/construction fleet activity 160c, and provides that data to the vehicle data collector 115 and/or statistics collector 120, as appropriate. The statistic collector 120 might also receive resource data 165 (e.g., vehicle baseline data) from one or more data sources, such as public databases, private databases, etc. As noted above, these collectors receive the data, process it as necessary, and provide the processed data to the database management system 110 for storage, at which point the performance analysis module 125a might analyze the carbon output performance of the various vehicles being tracked, and/or the report preparation module might prepare a report or other feedback 170 (either on a batch/scheduled basis, or on request), to be provided to one or more users.

In certain embodiments, the system 100 also includes a heuristic inference manager 175 (sometimes described herein as an “inference manager”). In an aspect, the inference manager 175 is a predictive modeling tool that functions to predict what mode of transport (e.g., a particular vehicle or type of vehicle, walking, public transport, etc.) is being used to deliver the tracking data. In another aspect, the inference manager is designed to mimic a human analyzing the data to make a reasonable guess or estimate of the mode of transport. Accordingly, the inference manager 175 may use fuzzy logic and/or Bayesian probabilities to produce inferences about a mode of transport, based on various characteristics of the data received from a mobile tracking system. Typically, the inference manager 175 will receive operating data from a vehicle (e.g., via the vehicle data collector 115), and from that data, infer a mode of transport currently employed by the user. Optionally, the inference manager 175 might obtain resource data (e.g., via a statistics collector 120) that can inform the predictions made by the inference manager 175). In some cases, the inference manager 175 is a software component in the server 105. In other cases, the inference manager might be a software component within a mobile tracking system (e.g., within a tracking monitor system 140b, 140c, or a wireless device 140a with a tracking application).

The reader will note that various software components are illustrated in FIG. 1A as functionally separate. However, it should be appreciated that these components may be arranged in different fashion than illustrated by FIG. 1A. Merely by way of example, the vehicle data collector 115 might be integrated within the inference manager 175. Similarly, the performance analysis module 125, report preparation module 130, and/or inference manager 175 might be integrated with one another and/or the database management system 110.

FIG. 1B illustrates a system 100′ that functions similarly to the system 100 of FIG. 1A, except that the system 100′ can track carbon output from non-mobile activities. Merely by way of example, there are a wide variety of manufacturing activities that have carbon footprints and could benefit from both the tracking and the possibility of becoming involved in various kinds of carbon trading business activities. Refineries, bakeries, light and heavy manufacturing activities that use fuel to produce energy to move, cook, process, light, heat, or otherwise conduct business all fall into this category. These activities involve processes that are contained in one locale, as opposed to the carbon producing activities associated with the movement of goods and people. In various embodiments, the system 100′ can track individual user activities 180a, small business user activities 180b, and/or activities 180c of large corporations/enterprises. A variety of devices and/or techniques may be used to track such activities. Examples include, without limitation, wireless devices 185a (which might have an application for inputting and/or tracking atmospheric carbon output, similar to the mobile tracking application described above with respect to the wireless device 140a illustrated in FIG. 1A. Other examples of tracking/communication techniques can include, again without limitation, the Internet 185b, electronic and/or postal mail 185c, and/or the like. In some cases, the activities might be tracked through the use of particular devices designed to track atmospheric carbon output and/or data that can proxy for carbon output (such usage of electricity, oil, or other input resources). Such devices can include exhaust monitoring systems, “smart” utility meters and/or appliances, and/or the like. In other cases, atmospheric carbon output may be tracked via user input (e.g., via an email message, input to a web site, etc.) that documents the output (which the user might ascertain through offline measurements, such as utility bills, etc.).

The tracking data is received by the server 100′ via one or more communication networks 145, as in the system 100 of FIG. 1A The communication manager 155 receives data about various non-mobile activities, including individual user activity data 190a, small business activity data 160b, and/or corporate/enterprise activity 160c, and provides that data to a stationary emitter data collector 195 (which is similar to the vehicle data collector 115, except that it collects data on non-mobile carbon outputs) and/or statistics collector 120 (which may also function to collect statistics and/or background/baseline data on stationary emissions), as appropriate. From that point, the system 100′ operates similarly to the system 100 of FIG. 1A (except that it should be recognized that the nature of the analysis and/or reports might vary between mobile and non-mobile sources).

In some cases, the systems 100 and 100′ of FIGS. 1A and 1B, respectively, may be combined as a single system, either with discrete functional blocks for mobile and non-mobile sources, or with consolidated functional blocks. Merely by way of example, the stationary emitter data collector 195 and the vehicle data collector 115 might be incorporated within a single data collector, which can distinguish between data received from mobile and non-mobile sources. Similarly, a single database management system 110 might manage multiple databases (e.g., one for mobile sources and one for stationary sources) and/or might manage a single database for both types of carbon output sources.

In an aspect, the server 105 provides a user interface. The user interface allows users to interact with the server 105. A variety of user interfaces may be provided in accordance with various embodiments, including without limitation graphical user interfaces that display, for a user, display screens for providing information to the user and/or receiving user input from a user.

Merely by way of example, in some embodiments, the server 105 may be configured to communicate with a client computer, which might be a wireless device (e.g., 140a, 185a), a personal computer in communication with the server 105, etc., via a dedicated application running on the client computer; in this situation, the user interface might be displayed by the client computer, based on data and/or instructions provided by the server 105. In this situation, providing the user interface might comprise providing the instructions and/or data to cause the client computer to display the user interface, and/or providing data (e.g., feedback on carbon output, as described later) to be displayed by a user interface generated by a client application on the client computer. Similarly, providing a user interface from the server 105 might comprise receiving at the server 105 user input that is collected from a user interface generated by the client application on the client computer.

In other embodiments, the user interface may be provided from a web site that is provided by the server 105, e.g., by providing a set of one or more web pages, which may be displayed in a web browser running on the client computer. One skilled in the art will appreciate that web pages generally are transmitted by a web server (not shown on FIGS. 1A and 1B) for reception by a web browser or other client application at a client computer. In various embodiments, the server 105 might comprise the web server and/or be in communication with the web server, such that the server 105 provides data to the web server, which can then incorporate the data in web pages served for display by a browser at the client computer.

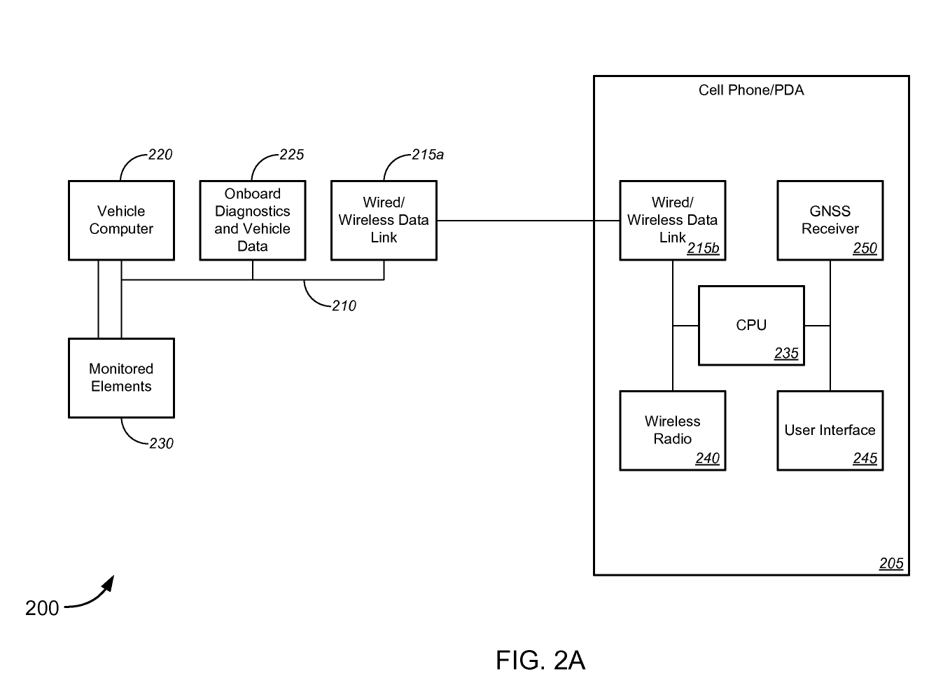

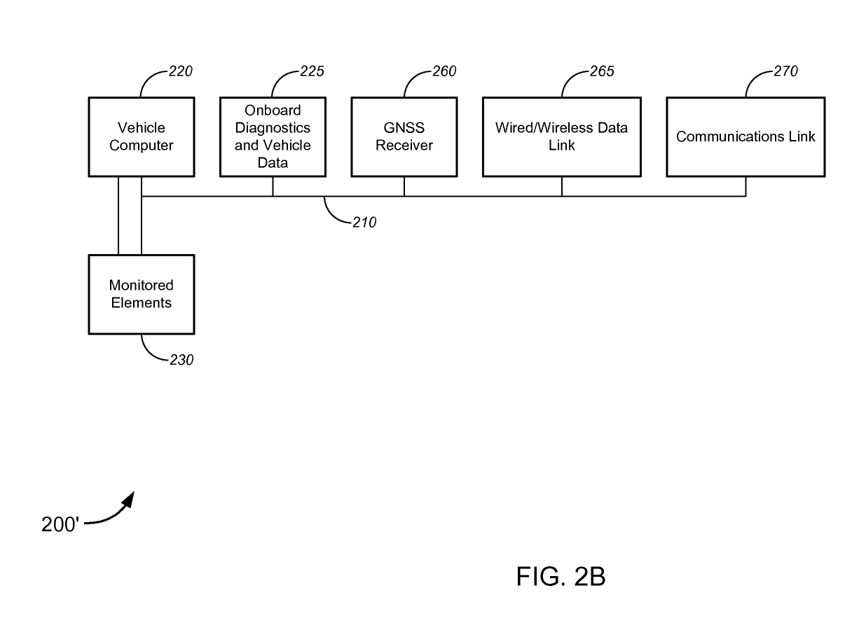

FIGS. 2A and 2B illustrate a set of mobile components that may be employed as mobile tracking systems for tracking atmospheric carbon output, in accordance with various embodiments. FIG. 2A illustrates a system 200 that employs a wireless device 205, such as a cellular phone, PDA, etc., while FIG. 2B illustrates a system 200′ than can be used without a separate wireless device.

In addition to the wireless device 205, the system 200 of FIG. 2A might comprise a communication bus 210, which can be implemented using any architecture that provides data communication among the various components of the system 200. In the illustrated embodiment, a data link 215 provides communication between the wireless device 205 and the communication bus 210 (and/or other components of the system 200). The data link 215 can, in various embodiments, be a wired data link (e.g., a USB connection, a serial connection, etc.) and/or a wireless data link (e.g., a Bluetooth connection, a WiFi connection, an RF connection, etc.). One skilled in the art will appreciate that the data link typically will comprise a component 215a in communication with the communication bus 210 (or other components) and a second component 215b within the wireless device; the nature of these components will depend on the type of data link, but they can include, without limitation, RF transceivers, Bluetooth transceivers, USB ports, other wired communication ports, WiFi radios, etc.

The system 200 may also include (or provide communication with) an onboard computer 220 in the vehicle (e.g., a navigational computer, a trip computer, a multipurpose computer that controls various vehicle operation, comfort and/or communication systems, etc.) and/or an onboard diagnostics/vehicle data collector 220 (e.g., an electronic control unit, an ODBII unit, etc.). The system 100 might include other specialized sensors (not depicted on FIG. 2A), such as emissions sensors, fuel consumption sensors, speedometers, tachometers, etc.). Together, these sensors, the onboard computer 220 and/or the onboard diagnostics/vehicle data collector can collect data about one or more monitored elements 230, including the vehicle's operating parameters (fuel consumption, engine RPM, gear ratios, vehicle position, movement direction and/or velocity, etc.).

The wireless device 205 typically will comprise, in addition to the data link component 215b, a processor 235, a wireless radio 240, a user interface 245 (often comprising a display screen and one or more input devices, such as keyboards, touch screens, pointing devices, etc.), and/or optionally, a GNSS receiver 250. The wireless device 205 generally will also comprise a computer readable medium (not illustrated on FIG. 2A), which is used to store data collected from the vehicle, as well as an application program that is executable by the wireless to perform operations for tracking carbon output, as described in further detail below. In operation, the wireless device 205 receives data collected from the various other components of the system 200 (along with positional data from the GNSS receiver 240, in some cases), and transmits that information, via the wireless radio 240 in most cases, for reception by a server (e.g., the server 105 described in conjunction with FIG. 1A above). The application might also provide for user interaction, as described further below, via the user interface 245.

The system 200′ of FIG. 2B is similar to the system 200 of FIG. 2A, except that it does not employ a wireless device. Hence, the system 200′ typically will be installed, in its entirety in a particular vehicle to be monitored. (Often the system 200′ will be a component of a larger fleet management system, such as the GeoManager system described above). Accordingly, in the system 200′, some or all of the functionality of the wireless device 205 of FIG. 2A is incorporated into installed components (e.g., the vehicle computer 220, etc.). Additionally, the system 200′ might comprise a discrete GNSS receiver 260; a data link 265, which can provide communication with other devices as necessary; and/or a communication link 270, which can provide communication (e.g., via cellular or other wireless transmission, satellite transmission, etc.) with a communication network such as the communication networks 145, 145c described above with respect to FIG. 1A.

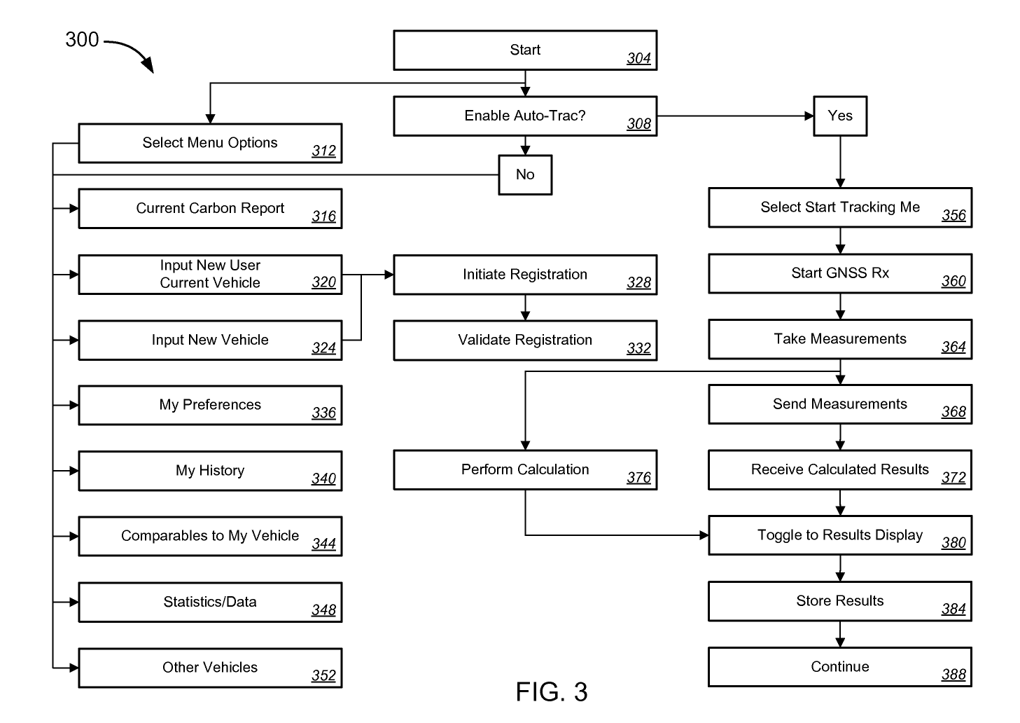

As noted above, in some embodiments, a mobile tracking system is used to collect information on vehicular carbon emissions. FIG. 3 illustrates a set of functions that can be provided to a user (through a user interface) by a carbon tracking application 300 in a mobile tracking system. Such an application might be implemented, for example, as software, firmware, or hardware instructions installed on a wireless device (such as the wireless devices 140a, 185a, and/or 205 described above), a computer (such as the computer 220 described above), and/or a tracking monitor system (such as tracking monitor systems 140b, 140c described above).

From a start block 304 (which might represent, for example, an opening screen of the application 300), the user is presented with the option to enable automatic carbon tracking (block 308). (Unless specified otherwise, the term “user” should be interpreted to include individual users, as well users who are members or employees of a corporation or other enterprise.) If the user elects not to enable the automatic carbon tracking feature, the user is presented with a set of menu options from which the user may select (block 312).

These options may include, without limitation, display of a current carbon report (block 316). As noted in further detail below, embodiments provide the ability to generate reports about a user's atmospheric carbon output (or the atmospheric carbon output of one or more of the user's vehicles), and selection of this option will display such a report via the user interface. (Such a report may be generated at a server and provided to the device on which the application runs, or the report may be generated at the device itself.)

The user may also select an option to input a new user for the current vehicle (block 320) or input a new vehicle for the current user (block 324). In either case, the application 300 will initiate a registration process (block 328) to register a new vehicle for the user or to register the vehicle with a new user, as appropriate. An exemplary vehicle registration process is described in detail below, but in general, the registration process establishes an association between a particular vehicle and user, so that carbon output from that vehicle can be tracked and associated with the user. After the registration process has been completed, it may be verified (block 332) to ensure that the registration is correct. This verification, for example could involve performing a check with an appropriate regulatory body to determine whether the identified VIN is a correct number and additionally is indeed registered to the user that provided it. Alternatively, the verification could involve checking the VIN vial validation algorithm that is configured to identify correct VINs and/or verifying that the identified VIN corresponds to the equipment specified during the registration process.

The application 300 can also offer the user the opportunity to view and/or adjust the user's preferences (block 336). Typical preferences can include, without limitation, a default vehicle for the user, default report formats, reporting frequencies, display options, etc.

The application may also provide the user with a facility to view historical information (block 340), such as historical carbon output, routes and/or miles driven historically by the current vehicle, etc. By way of example, in one embodiment, the application 300 might display historical carbon output on a trip-by-trip basis, on a periodic (e.g., daily, weekly, monthly, etc.) basis, and/or the like. The historical information might be categorized by vehicle, trip, etc. A wide variety of historical information can be provided in accordance with various embodiments. The historical information might be stored on the mobile tracking system and/or obtained from a server as necessary.

In an embodiment, the application can display for the user a set of vehicles comparable to the user's currently selected vehicle (or any other registered vehicle) (block 344). Comparable vehicles can include vehicles in a similar class, vehicles of a similar size, age, and/or price, vehicles with similar carbon output, and/or the like. In other embodiments, the user might be able to select comparable vehicles to view, and/or a variety of different vehicles (which might or might not have similar characteristics to the user's vehicles) in order to see how the carbon output of such vehicles might compare to the carbon output of the user's vehicles. In some embodiments, the application 300 might be configured to calculate and/or display for the user a hypothetical carbon output value for one or more comparable vehicles under various conditions, including without limitation conditions similar to those for which carbon output from the user's current vehicle (or other of the user's vehicles) has been (or is currently being) tracked.

The application 300 might also offer the user the ability to view statistics and/or data about the current vehicle (block 348). Exemplary statistics could include miles per gallon, carbon output, other gaseous outputs, and/or the like.

If the user chooses to enable automatic tracking, the application 300 begins tracking the vehicle's carbon output. Various embodiments offer many different techniques to track carbon output (several of which are discussed below), and FIG. 3 illustrates one such technique. In accordance with the illustrated embodiment, the application 300 provides an interface element (such as a button, etc.) to allow the user to instruct the system to begin tracking carbon output (block 356). (In some cases, this procedure may be unnecessary if the user has already enabled automatic tracking.)

In the illustrated embodiment, the application 300 begins receiving location data (such as GNSS positional information (block 360). Periodically (e.g., every 10 seconds, every minute, every five minutes, etc.), the application 300 collects and/or stores measurements, such as information about the vehicle's current position (block 364) In one embodiment, the application 300 and/or the server associates each position fix with a time stamp. In another embodiment, the application 300 might collect and/or store other measurements of vehicle operating parameters (e.g., from the vehicle's data bus), such as engine RPM values, vehicle speed, gearing, etc. The frequency of reporting may be adjusted to suit the user's needs for meeting data reporting standards for federal agencies, or for a specific user requirement.

In one set of embodiments, the application 300 sends some or all of the collected measurements (e.g., position information, etc.) to a server (block 368). From these measurements, the server can calculate an estimated carbon output value (e.g., by calculating the vehicle's velocity and/or change of altitude from the position information and associated time stamp and estimating the carbon output based on vehicle characteristics, and/or using more sophisticated techniques such as those described below). Accordingly, in some cases, the application 300 receives the results of the carbon output calculations (block 372). In other embodiments, the application 300 might be capable of performing some or all of the calculations itself (block 376), in which case, communication with the server might be unnecessary. In either cases, the results of the calculations (e.g., carbon output values) may be displayed for the user (in real time, or near real time, if desired) on a display of the PDA or other device on which the application 300 is executing (block 380), and/or the calculation results might be stored by the application 300 (block 384), e.g., on a storage medium in the device on which the application 300 is executing.

The application might then continue (block 388) to the start block 304, e.g., when the position information and/or vehicle operating parameters indicate that the vehicle has come to rest for a certain period, has been turned off, etc., and/or based upon user input requesting that the application 300 stop automatically tracking carbon output. In other embodiments, the application might reiterate the tracking process (i.e., blocks 360-380) to provide a continuously updating display of carbon output values while the user is driving the vehicle.

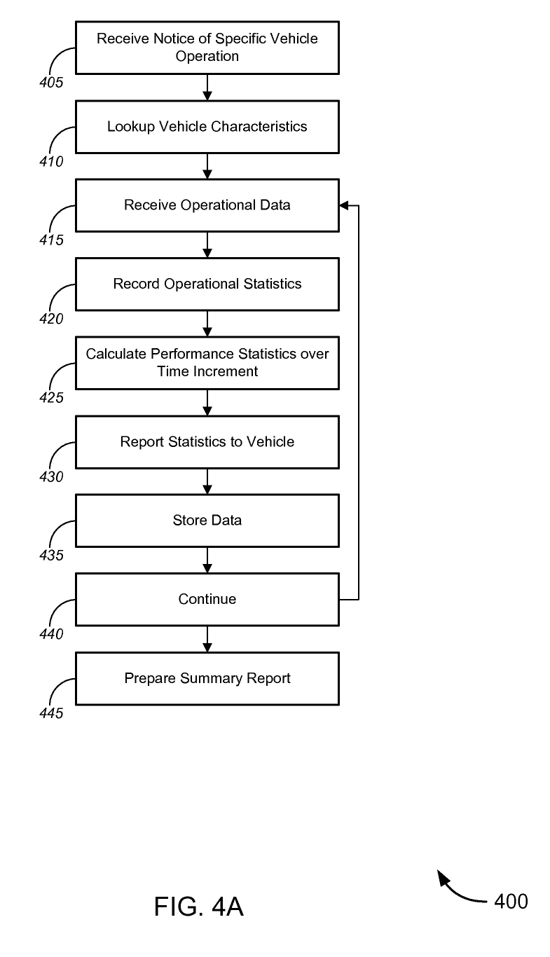

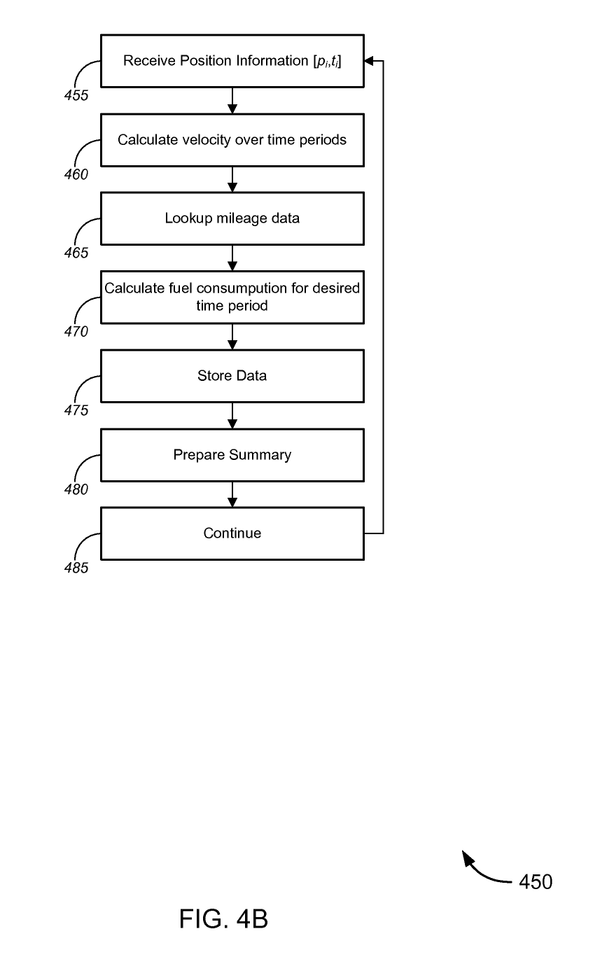

FIGS. 4A, 4B, 5-8, 13, and 14 illustrate various methods that can be used to track a user's carbon output and perform associated functions. While the methods of FIGS. 4A, 4B, 5-8, 13, and 14 are illustrated, for ease of description, as different methods, it should be appreciated that the various techniques and procedures of these methods can be combined in any suitable fashion, and that, in some embodiments, the methods depicted by FIGS. 4A, 4B, 5-8, 13, and 14 can be considered interoperable and/or as portions of a single method. Similarly, while the techniques and procedures are depicted and/or described in a certain order for purposes of illustration, it should be appreciated that certain procedures may be reordered and/or omitted within the scope of various embodiments. Moreover, while the methods illustrated by FIGS. 4A, 4B, 5-8, 13, and 14 can be implemented by (and, in some cases, are described below with respect to) the systems illustrated FIGS. 1A, 1B, 2A, 2B and 3 (or components thereof), these methods may also be implemented using any suitable hardware implementation. Similarly, while such systems (and/or components thereof) can operate according to the methods illustrated by FIGS. 1A, 1B, 2A, 2B and 3 (e.g., by executing instructions embodied on a computer readable medium), such systems can also operate according to other modes of operation and/or perform other suitable procedures.

As noted above, various embodiments can be used to calculate a vehicle's atmospheric carbon output and report that information to a user of a vehicle (or another) to enable the user to make behavioral decisions based on immediate feedback about the user's behavioral decisions (e.g., selection of vehicle, driving style, etc.) and the resulting impact on the user's carbon footprint. There are a wide variety of ways in which to calculate a vehicle's carbon output value, but the basic theory balances the mass of carbon in the intake fuel with the mass of carbon output in the vehicle's exhaust. Accordingly, if the amount of fuel intake over a certain time interval (and the composition of the fuel) can be determined, the system can calculate an estimate of the amount of carbon output by the vehicle over that interval. The output rate of atmospheric carbon, then, can be determined by dividing the overall carbon output for the interval by the duration of the interval.

The United States government has published greenhouse gas estimates for a variety of fuels. For example, diesel fuel produces 22.384 pounds of carbon dioxide per gallon consumed, while gasoline produces 19.564 pounds of carbon dioxide per gallon consumed. See U.S. Energy Information Administration, Voluntary Reporting of Greenhouse Gases Program, Fuel and Energy Source Codes and Emission Coefficients. Similar data for other fuels is available as well.

Hence, certain embodiments can calculate a vehicle's atmospheric carbon output based on the vehicle's fuel consumption. There are a variety of techniques that can be used, ranging from the relatively simple (measuring the miles driven per tank of fuel consumed, where the tank volume is known) to more complex, fine-grained analysis involving engine operating conditions over relatively short intervals. Each calculation technique has relative advantages, but as a general rule, more fine-grained analysis can provide more precise and immediate feedback to a user. For example, carbon output reporting on a per-tank basis will provide the user with relatively scant information about how driving behavior (as opposed to the nature of the driven vehicle itself) affects carbon output, because the user will not receive feedback on carbon output until the current tank of fuel has been consumed. On the other hand, real-time (or near real-time) reporting based on actual operating parameters of the vehicle will provide immediate feedback to the user on the carbon output effect of driving behaviors such as jackrabbit starts, etc. The methods described below illustrate the use of a variety of techniques for calculating carbon output, each of which may be advantageous in particular situations.

Merely by way of example, FIGS. 4A and 4B illustrate methods 400 and 450, respectively, of tracking a vehicle's atmospheric carbon output and/or other statistics. The methods 400 and 450 are described herein as being performed on a server, but they can also be performed by an application on a vehicle monitoring system as well. The method 400 uses a vehicle's operating parameters to calculate performance statistics (including without limitation atmospheric carbon output), while the method 450 uses the vehicle's position information to do the same. Hence, in an aspect, the method 400 might require operational data from the vehicle itself, while the method 450 merely requires location data (which can be obtained from, e.g., a GNSS receiver in the vehicle) without requiring any operational data from the vehicle itself. In an aspect, the methods 400 and 450 may be viewed as alternatives, while in another aspect, the two methods 400 and 450 may be used together.

The method 400 of FIG. 4A comprises receiving, e.g., at a server, notice of a specific vehicle's operation (block 405). Merely by way of example, in some cases, a server will receive notice from a mobile tracking device, a wireless device, and/or the like. The notice may be transmitted over a communication link as described above, and/or the notice might provide information about a vehicle for which carbon should be tracked. For example, the user might identify the vehicle using an application as described above. As another example, the mobile device might be able to collect sufficient data (e.g., from a communication link to an OBD system in the vehicle, from a Bluetooth link to the vehicle, etc.) to identify the vehicle without user input, or a default vehicle might be selected by the mobile device (e.g., the device might default to the last vehicle tracked, a defined default vehicle, etc.).

In an embodiment, the method 400 further comprises looking up vehicle characteristics for the identified vehicle (block 410). In some cases, these vehicle characteristics may be provided upon vehicle registration (described in further detail below) and/or otherwise provided by the user. In other cases, the server may maintain and/or have access to a database of characteristics for many different vehicles, and the server might search such a database to identify the relevant characteristics for the current vehicle. Relevant characteristics can include, without limitation, vehicle mileage (e.g., gallons of fuel consumed per mile driven), fuel type (e.g., unleaded gasoline, diesel, etc.), vehicle engine type, gear ratios, and/or the like.

At block 415, the server receives operational data from the vehicle (and/or a mobile tracking device, etc. associated with the vehicle). This operational data can include, without limitation, any of a variety of operating parameters of the vehicle, including without limitation, vehicle speed, vehicle position (including, in some cases, vehicle altitude information for use in recording and correlating fuel consumption with changes in altitude due to hill climbing), engine RPMs, transmission gearing, fuel consumption, and/or the like. Additionally, for some fleet owners, weather information might be useful, and such information can be obtained from public sources (based on current vehicle location) and/or from other kinds of weather-related sensors associated with the vehicle. For example, if the windshield wipers are turned on, that is noted in the onboard diagnostics reporting system, and could be reported as an indicator of inclement weather (rain conditions). Additionally and/or alternatively, weather information is commonly broadcast via AM/FM radio; and is available via numerous web sites, which a typical mobile device may have access to. In one respect, the system can provide to the server any operating parameters available from the vehicle that can be used to calculate performance statistics, including without limitation atmospheric carbon output.

At block 420, the server records statistics about the operation of the vehicle, which can include some or all of the operational data received by the server, statistics derived from the operational data, etc. in one aspect, the server records the statistics by saving them in a database. In another aspect, each statistic may be accompanied by a time stamp, which can be received along with the operational data and/or generated by the server itself upon receipt of the data.

At block 425, the server calculates performance statistics over particular time increment (e.g., between one time stamp and another). Merely by wave example, if the server receives operational data indicating particular values for engine RPM and vehicle speed at a first time and receives additional operational data indicating the same (or substantially similar) values for engine RPM at a second, subsequent time, server might infer that those values apply for the time increment between the time of the first time stamp and the time of the second time stamp. Consequently, the server could use those values to calculate performance statistics such as fuel economy (miles per gallon, etc.), atmospheric carbon output, and/or the like.

As noted above, atmospheric carbon output can be calculated (or at least estimated) based on the amount and type of fuel consumed. The type of fuel can be determined by the identity of the vehicle being tracked. In various embodiments, the server can determine the amount of fuel consumed over a particular interval in different ways. Merely by way of example, in some embodiments, the mobile tracking system of the vehicle might be able to acquire direct data about fuel consumed (e.g., if the vehicle's OBD sensors include a fuel consumption monitor, a fuel tank volume monitor, fuel injector monitors, etc.). In other embodiments, the amount of fuel consumed can be derived from engine RPM data, vehicle speed data, and/or the like.

In some embodiments, the server reports the calculated statistics to the vehicle (block 430), and/or, more precisely to a mobile tracking system/PDA, etc. associated with the vehicle; such a device might be, for example, the device from which the server receives the operational data). Additionally and/or alternatively, these performance statistics may be stored by the server and/or the device to which they are sent (block 435).

At block 440, the process reiterates, with the server receiving additional operational data. In this way, the server can perform calculations on received operational data and return results of those calculations to the vehicle on a continuous, real-time (or near real-time) basis. Additionally and/or alternatively, the server may prepare a summary report of vehicle performance over a particular period (e.g. a particular time interval, a trip, etc.) (block 445). This summary report may be prepared automatically and/or upon request from a user (which might be received from a mobile tracking system/PDA, via a Web interface, etc.); in one aspect, the server might prepare a summary report upon detecting that a trip has ended (either by receiving express notification from the vehicle that the trip has ended, by detecting that no new operational data has been received over a specified duration, etc.).

The method 450 of FIG. 4B can also be used to calculate and report carbon output, as well as other performance information, but it does not require collection of any operational data from the vehicle itself. Instead, the method 450 estimates fuel consumption data from position information received from a mobile device in the vehicle. In accordance with this method 450, for example, a mobile device with a GNSS receiver could be used to track carbon output without need for any communication link between any vehicle systems and the mobile device.

The method 450 may comprise certain operations depicted on FIG. 4A, such as receiving notice of a specific vehicle's operation and determining relevant vehicle characteristics (such as the type of fuel used by the vehicle), even though such operations are not illustrated on FIG. 4B. As illustrated, the method 450 comprises receiving (e.g., at a server) position information from the vehicle (and/or a mobile device located therein). In a particular aspect, each position fix may be considered a position/time pair {pᵢ,tᵢ}, comprising a position (e.g., a latitude/longitude coordinate pair, etc.) coupled with a time stamp for that position. The time stamp can comprise time information received from the vehicle and/or can comprise a time value generated by the server upon receiving a position fix from the vehicle. Based on the receipt of two position fixes and associated time stamps (e.g., {pᵢ, tᵢ}, {pᵢ₊₁, tᵢ₊₁}), the server can calculate a velocity vector (in one, two, or three dimensions) over a time period between the associated time stamps (block 460), using a standard velocity calculation:

$$\vec{v} = \frac{{p}_{i + 1} - {p}_{i}}{{t}_{i + 1} - {t}_{i}} \qquad ( Eq . 1 )$$

In an aspect of certain embodiments, the server stores (or has access to) one or more tables of fuel consumption (“mileage”) rates that correlate, for a particular vehicle or class of vehicles, and amount of fuel consumed per unit of time at a particular velocity (which may or may not include altitude gain/loss). Based on the known identity of the current vehicle and the calculated velocity of the vehicle, the server can look up an appropriate fuel consumption rate (block 465), and by multiplying that consumption rate by the length of the period (tᵢ₊₁−tᵢ), can calculate the amount of fuel consumed over the period (block 470). As noted above, the amount of atmospheric carbon generated can be calculated by multiplying the emission coefficient of the relevant fuel (which can be determined based on the identity of the vehicle) by the amount of fuel consumed over the relevant period.

The method 400 can include other operations similar to those described with respect to FIG. 4A, such as storing data (block 475), preparing, transmitting, and/or displaying summary reports of fuel consumption statistics, carbon generation statistics, etc. (block 480) and/or continuing the monitoring process (block 485).

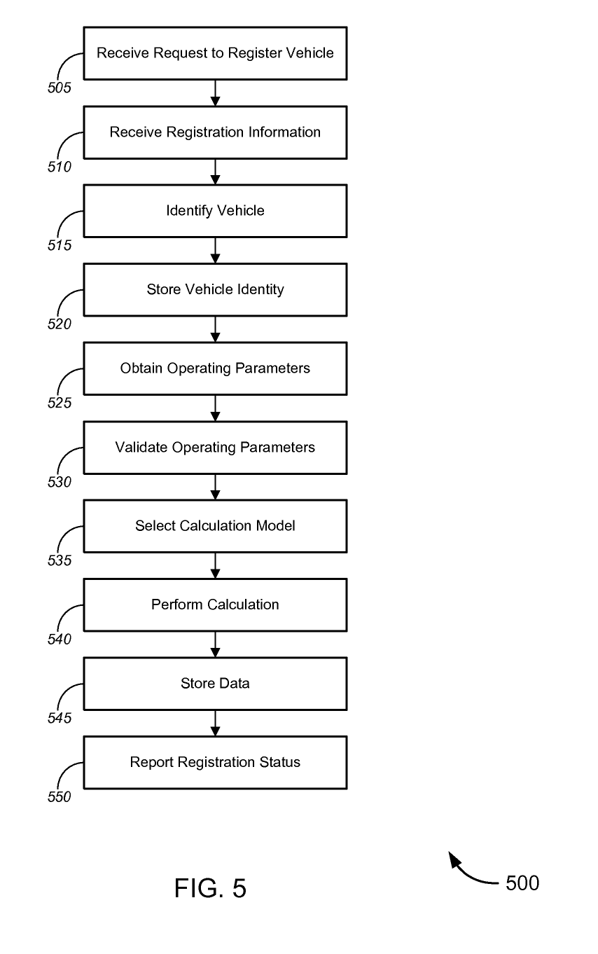

FIG. 5 illustrates a method 500 that can be used to register a vehicle with a carbon tracking system, so that carbon output for the vehicle can be tracked. The method 500 includes receiving (e.g., at a server) a request to register a vehicle (block 505). In many cases, the request may be received from a mobile device operated by user, for example based on a user's request to register a new vehicle in the user interface of such a device. In other cases, the request may be received via other routes, such as an e-mail message, a website, and/or the like.

The method 500 may further include receiving registration information about the vehicle (block 510). Such registration information may be provided with registration request, and/or the server may prompt for such information after receiving the registration request. Registration information can include any information that can be used to identify the vehicle, and may include sufficient information to identify the vehicle. Merely by way of example, in some cases the registration information will include the vehicle identification number (“VIN”). In other cases, the registration information might include the make, model, and/or year of the vehicle, along with any relevant standard or optional equipment, such as transmission type, engine type and/or displacement, fuel type, and/or the like. The user may provide the registration information as user input; alternatively, if supported by the hardware, mobile device might interrogate the vehicle itself to obtain the registration information, which it can then send to the server.

In some cases, the method 500 includes identifying the vehicle, perhaps based at least in part on the received registration information. For instance, if the registration information included a VIN number, identifying the vehicle might comprise identifying the make, model, and/or year of the vehicle, along with relevant standard and/or optional equipment. In an aspect of certain embodiments, identifying the vehicle may comprise decoding the VIN number, looking up the VIN number to identify the vehicle, and/or the like. In another aspect, the vehicle might be identified by an easily identifiable name, such as “<Year><Make><Model>” and/or, in some cases, the user might be given the opportunity to give the vehicle a name by which it should be identified.

The method 500 further includes storing the identity of the vehicle (block 520), e.g., in a database or other appropriate data store on the server and/or on a mobile device associated with the vehicle. In an aspect, storing the identity of the vehicle also comprises storing information about relevant characteristics of the vehicle, including without limitation make, model, and/or year of the vehicle, such as transmission type, engine type and/or displacement, fuel type, fuel economy statistics, and/or the like.

In some embodiments, the system will attempt to acquire operating parameters of the vehicle (e.g., via a mobile device) during vehicle registration (block 525). Examples of such parameters are described above. In some cases, the system may prompt the user to place the mobile device in communication with the vehicle, or to provide user input that such communication is not available. If the user indicates that a connection is not available, or if no parameters can be obtained even after a connection has been established, the system may determine that operating parameters are not available from the current vehicle. If the system is able to obtain operating parameters, it may attempt to validate those parameters (block 530) to ensure that the data obtained from the vehicle is consistent with what is expected. For example, the system may instruct the user to drive at a certain velocity and/or in a certain gear, or to maintain the engine at a particular RPM, and then compare the obtained data with the data that would be expected under the prescribed conditions. As another example, the system might compare the obtained parameters with other, known-good data about the same type of vehicle.

At block 535, the system selects a default calculation model for the registered vehicle. A calculation model defines how atmospheric carbon output (and/or other performance statistics) will be calculated/estimated by the system. There are a variety of calculation models that may be selected; FIGS. 4A and 4B illustrate two such models. The selection from among may be based on user input, and/or may be based on other factors. Merely by way of example, if the system's attempts to obtain and/or validate a vehicle's operating parameters fails, the system may select a position-based calculation model, such as that depicted by FIG. 4B; conversely, if such attempts are successful, the system may select a model based on the vehicle's operating parameters. Other factors might augur in favor of other calculation models. In some cases, the system may perform a test calculation during registration (block 540), using the selected calculation model, to ensure that the model will produce valid results.

At block 545, the system might store the registration data, including the vehicle identity (if not already stored), the calculation model, the user's identity, and/or any other relevant information. At block 550, the system reports the vehicle's registration state (e.g., whether the requested registration was successful) to the user. Generally, this report will be provided as feedback in a user interface of the device from which the user requested the registration.

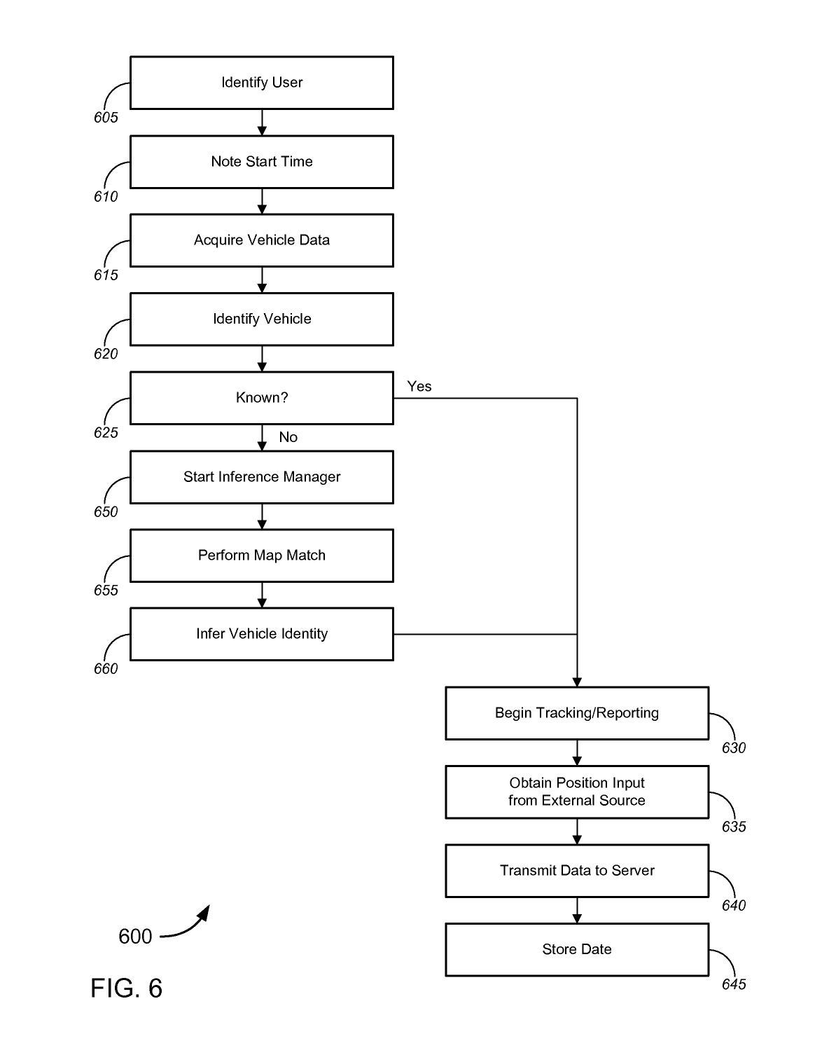

The methods of FIGS. 4A and 4B illustrate methods of tracking carbon use that, in certain aspects, may assume that the identity of the vehicle has been provided or otherwise ascertained. FIG. 6 illustrates a method 600 that can be used to identify a user's vehicle (or more generally, a user's mode of conveyance). The method 600 includes identifying a user (block 605). In various embodiments, a user might be identified in different ways. Merely by way of example, in some cases, the user might log into a service using a typical authentication challenge-response technique (e.g., userid and password). In other cases, a server might identify a user based on identifying information (e.g., user identifier, device serial number, MAC address, etc.) provided to the server by a mobile device operated by the user. In cases in which carbon tracking is performed locally at a mobile device, user identification might be implicit (i.e., only one user operates the mobile device).

The method 600 further comprises recording a start time for the tracking session (block 610) and/or acquiring vehicle data, e.g., from the mobile device, from the user, and/or from the vehicle itself (block 615). Such vehicle data might include data from which the vehicle can be identified, such as a vehicle identity (assigned during registration, as noted above), a VIN, etc. Based on this information, the system will attempt to identify the vehicle (block 620), e.g., by searching a vehicle database at a server for a record matching the provided information, and then will determine whether the vehicle can in fact be identified from the available information (block 625).

If the vehicle is known (i.e., can be identified from the available information, the system continues to perform tracking/reporting operations (block 630), which can include operations such as those described with respect to FIGS. 4A and 4B above. For example, the mobile device might obtain position/time data (e.g., from a GNSS receiver, from cellular triangulation, from WiFi triangulation, etc.) (block 635), transmit that data to a server (block 640) for calculation of performance statistics (recognizing, of course, that such calculations could also be performed locally on the device in some embodiments) and/or store the data (block 645), either locally at the mobile device and/or at the server.

On the other hand, if the vehicle cannot be identified from the currently available information, the method might include invoking an inference manager (block 650) and/or performing a map-matching routine (block 655) to infer the identity of the current vehicle (or, more generally, to infer the user's current mode of conveyance), at block 660. For example, the map-matching routing might infer that the user is currently in an auto; this inference can be combined with information about the user's vehicle registrations to determine that the user is driving his primary car (assuming the user has registered his primary car, along with a motorcycle, a truck, and a bicycle with the system). Once the vehicle identity has been inferred, the process can proceed to tracking and/or reporting operations at block 630, as described above.

Hence, in some embodiments, a heuristic inference manager can be used to infer information about vehicle identity and/or behavior that may not be readily apparent from the data available from the vehicle itself (or, more specifically, from the mobile device in the vehicle). In one aspect, a heuristic inference manager (“HIM”) is a predictive modeling tool that is provided by the software on a mobile tracking system server, or in some cases, the software on a mobile device. In certain embodiments, the purpose of the HIM is to predict what mode of transport is being used to deliver the tracking data. The HIM is designed to mimic a human analyzing the data to make a reasonable guess or estimate of the mode of transport.

In a particular embodiment, the process employed by the HIM is multi-stepped, and starts with recognizing where the user is on a map with additional data about that location, including such items as, if the user (represented by a wireless device/mobile tracking device) is on a road or highway, what lane is user in? Is the user on the edge of the road, or on the sidewalk? Alternatively, is the user is on a known path such as a sidewalk or a foot path or a bike path? Such information about the user's location allows the system to make use of Bayesian probabilities and statistics we can improve over time, based on our observations. The use of Bayesian probabilities in making inferences are well known. See, for example, Lee, Peter M. Bayesian Statistics: an introduction. London: Arnold, Wiley, 2004, and Tanner, Martin A. Tools for Statistical Inference Methods for the Exploration of Posterior Distributions and Likelihood Functions (Springer Series in Statistics). New York: Springer, 1998, both of which disclose Bayesian theory and computational methods and are incorporated herein by reference.

The fundamental concept in applying Bayesian probabilities to vehicle identification is that if one knows something about the location, then suitable probabilities can be developed that are conditioned on that initial element of information, and a more intelligent estimate of vehicle identity and/or behavior can be made. Expressed in term of betting odds, the posterior odds are equal to the prior odds multiplied by a Bayes factor. By way of example, if the likelihood of a driver operating any of three possible modes of transport is equal for an automobile, bicycle, or motorcycle, then the probability he is using one of these modes is 0.33. But if it is known from the data being collected that the user's mobile device is being conveyed along a major highway at 70 mph, it is reasonable to infer that the vehicle doing the conveying is not a bicycle, a walker, or even a motor-bike; it can only be part of a subset of vehicles, including autos, trucks, and motorcycles. Thus the probability of motorcycle and auto are increased by a Bayes factor greater than 1, from 0.33 to something higher, and the probabilities of other modes of operation are reduced considerably, even to zero. Further analysis of the data may reveal very fast accelerations and fast stops, which would further increase the Bayes factor for the probability that the conveyance is a motorcycle, and conversely reduce the Bayes factor for the probability that the conveyance is an auto or a truck.

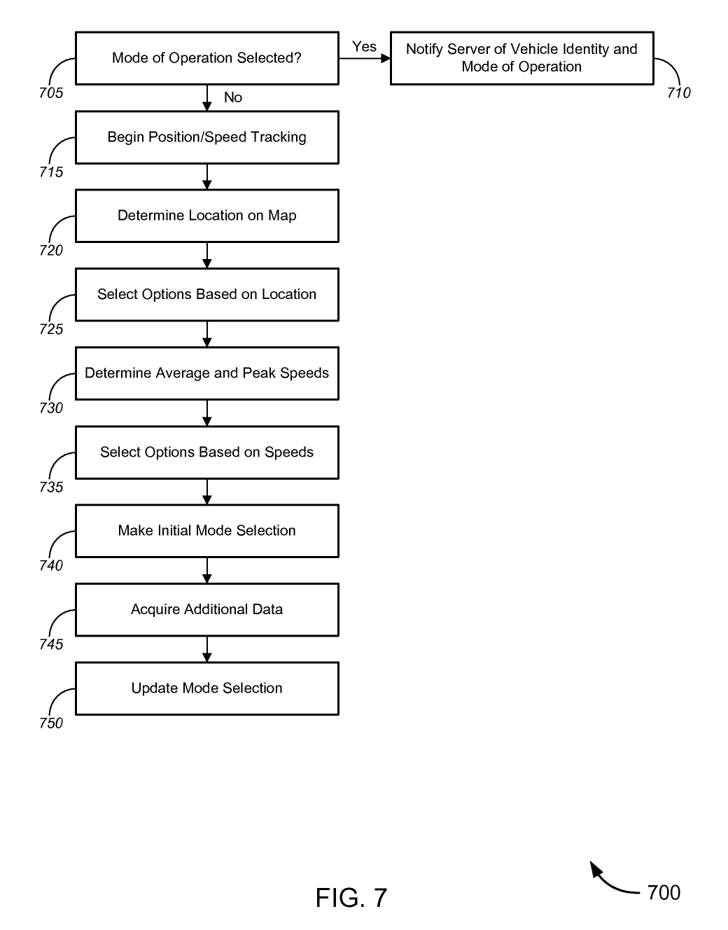

FIG. 7 illustrates a relatively general example of a HIM inference method 700, which can infer a mode of conveyance (and/or vehicle identity) based on location and/ speed information, which can be obtained, for example, from GNSS data received by a mobile tracking device without the need for vehicle-specific inputs. The method 700 first determines whether a mode of operation (conveyance) has been selected by the user (block 705). For example, in some embodiments, the system might provide, in the user interface, the user with the ability to submit user input specifying a mode of conveyance. In such a circumstance, the use of the HIM may be unnecessary, and the mobile device might merely notify the server of the vehicle identity and/or mode of operation/conveyance (block 710).

In other cases, however (for example, where the system does not provide for user selection of mode of operation, where the user finds it more convenient not to expressly select a mode of conveyance, or where the user forgets to select a mode of conveyance), the HIM might employ a map-matching technique to infer the mode of conveyance. In accordance with such a technique, the HIM begins tracking position and/or speed information (e.g., based on respective position/time data pairs) (block 715). From the position information, the HIM determines the position of the user, typically by reference to a map (block 720). More specifically, the HIM attempts to determine whether the user is on a road, what type of road (e.g., interstate highway, access road, etc.) and/or the user's location in relation to the road (e.g., a vehicle lane—and/or which one—a bicycle lane, a sidewalk, etc.).

Based on the location information, the HIM can compute a list of one or more probable options for the user's mode of conveyance (based, in some cases, on Bayesian analysis). For example, if the user is on a sidewalk, the HIM likely would discount as possible options any sort of motorized transport. In one embodiment, the list of possible options is filtered by the user's list of registered vehicles/modes of conveyance. In another embodiment, however, the possible options might not be limited in this way (which can allow a HIM-based system, in certain aspects, to accommodate vehicles/modes of conveyance that have not yet been registered by the user). In some cases, the HIM may be left with a single possible mode of conveyance at this point, and that mode of conveyance can be inferred by the HIM to be the current mode of operation.

In other cases, location information alone will not provide a sufficient basis for a reasonable inference of the user's mode of conveyance. In such cases, the HIM might also factor velocity information into the analysis. Hence, the method 700 can further include determining an average and/or peak speed (block 730) over a given period of time (for example, the length of the trip, some specified interval, the length of time for which the user's location has corresponded to a particular road, etc.). It should be apparent that such calculations can be performed using one or more position/time data pairs as input. The HIM then can select a list of possible options (perhaps by further limiting the list of options selected based on the location information) based on the speed information (block 735).

From this list of possible options, the HIM selects a vehicle/mode of conveyance as being the most likely current mode of operation for the user (block 740). In many cases, the location information and/or speed information will provide a sufficient basis for the HIM to select a particular vehicle. In other cases, additional information may be used to make the selection from the list of possible options identified by the HIM. Merely by way of example, the user's historical activities might be used to inform the selection—for instance, if the user has traveled the same route at a similar speed in the past using a known vehicle in the list of possible options, that vehicle might be selected. As another example, other vehicle operating parameters (acceleration, etc.) might be considered, as described in further detail below.

In some embodiments, the mode selection process may be repeated periodically and/or upon detection of a material difference in location (e.g., relative to a particular road) and/or speed. Hence, at block 745, the system might acquire and analyze additional location and/or speed data (as described above), and at block 750, the system might update the selection of the most likely mode of operation based on this additional data.

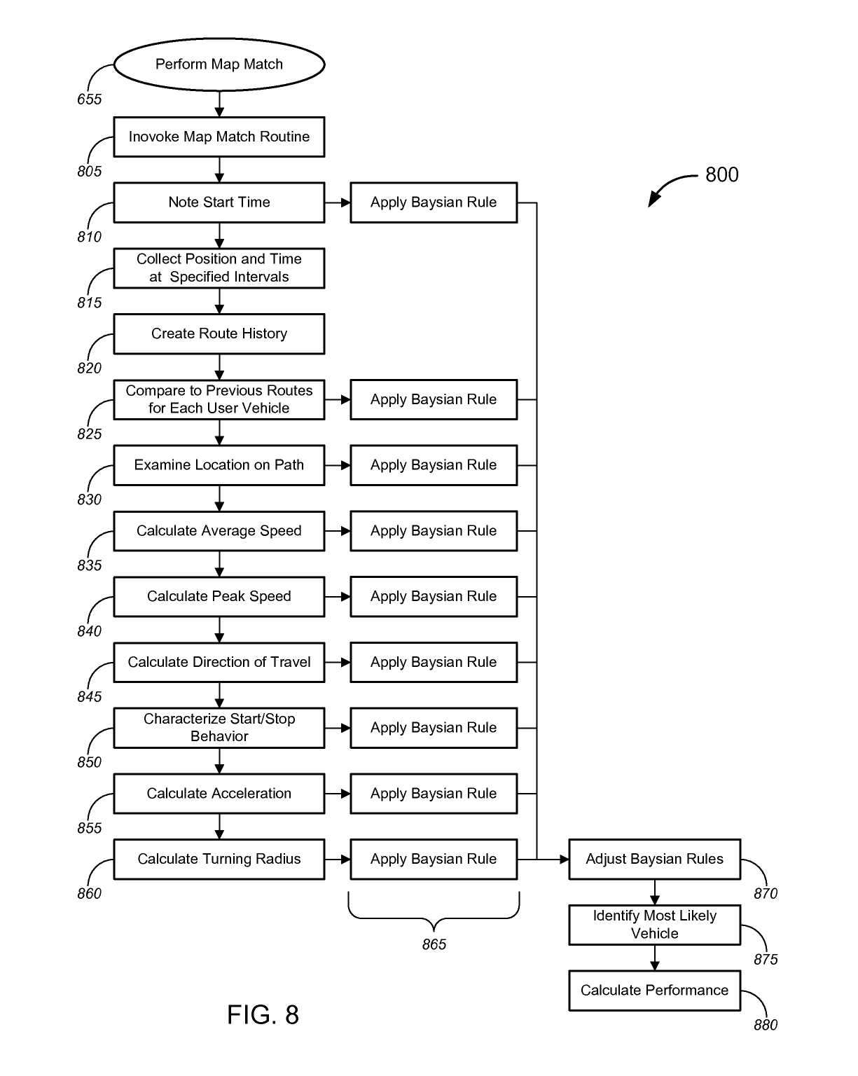

While FIG. 7 illustrates a generalized example of a map-matching technique that might be employed by a HIM, FIG. 8 illustrates a more sophisticated method 800 that might be performed by certain embodiments. The technique demonstrated by FIG. 8 can be used, for example, to perform the operation of performing a map match (block 655) and inferring the identity of a vehicle (block 660), as described in conjunction with FIG. 6.

In accordance with the method 800, the HIM invokes a map-matching routine (block 805). The map-matching routine collects data along one or more a variety of dimensions (as illustrated by blocks 810-860 and described further below) and applies a Bayesian rule to each of those dimensions (collectively illustrated by blocks 865). It should be noted that the HIM, in different circumstances, may use any combination of one or more these dimensions to infer a mode of operation, for example, by creating a list of possible options based on analysis of one of the data dimensions, and by further narrowing (and/or adding to) that list based on analysis of one or more additional data dimensions, until one possible option is of sufficiently high probability that the mode of operation can be inferred.

For instance, the method 800 comprises recording a start time for the trip (block 810). In some cases, this data dimension might be analyzed against a Bayesian rule. Depending on the date, the day of the week and/or the start time of the trip, certain vehicles might be more likely candidates than others. For example, if the user commonly goes for a bicycle ride on Saturday mornings in the summer but drives his car to work every weekday at 7:00 am, a trip starting at 9:00 am on a Saturday in July might indicate a relatively higher probability that the user is on a bicycle than a trip starting at 7:05 on a Tuesday.

At block 815, the method comprises collecting position and/or time data at specified (or arbitrary) intervals, as described above, and at block 820, the method comprises creating a route history for the trip. A route history, in one aspect, is a set of waypoints on the trip (optionally with associated times, which can be recorded either as absolute times or times relative to the beginning of the trip). This route history, which may be saved persistently (either locally at the device or on a server) can be compared to previously-saved route histories for that user (block 825). The route history can be evaluated against a Bayesian rule, for example if the route is similar to a route that commonly is taken by a particular vehicle, that vehicle can be prioritized as a possible option for selection as the current mode of operation.

At block 830, the location and/or path may be identified and, the location or path may be evaluated against a Bayesian rule, as described above, and/or the vehicle peak speed (block 835) and/or average speed (block 840) may be calculated and/or evaluated against an appropriate Bayesian rule, also as described above. Either or both of these two factors can be considered by the HIM in developing/refining the list of possible options for the current mode of operation (i.e., current vehicle or other mode of conveyance).

The system may also evaluate the position/time information to calculate the direction of travel (block 845), and/or analyze the direction of travel against a Bayesian rule. If, for example the direction of travel is against traffic, then the mode of conveyance may be more likely to be a bicycle or walking, especially if the data further indicates that the user's location is on the edge of a road or beside a road, and that the user's speed is low.

In some embodiments, the method 800 includes characterizing the start and/or stop behavior of the user (block 845). Starts and stops can be identified based on position and/or time information collected by the mobile device. Start/stop behavior may be evaluated against an appropriate Bayesian rule, and in some cases with respect to the user's location. Merely by way of example, if the user's behavior includes starts and stops that correspond to stop signs in a residential neighborhood, that behavior might be more likely to indicate the use of a motor vehicle than the use of a bicycle.

The system may also regulate values for the user's acceleration (block 855), e.g., from position and/or time information collected by the device. Once again, this data dimension may be evaluated against an appropriate Bayesian rule. For instance, relatively high acceleration values may indicate that the mode of conveyance is a motorcycle or sports car, rather than a large passenger sedan or truck (or a bicycle or walking). It should be noted that acceleration may be calculated in more than one dimension, because, for example, a user on a motorcycle may experience more lateral acceleration (e.g., from frequent lane changes) then a user driving an automobile or a truck.

In some embodiments, the turning radius of the user's mode of conveyance may be calculated (block 860), e.g., based on position and/or time information collected by the device, and that turning radius information may be evaluated against an appropriate Bayesian rule. Thus, for example, if the positional information indicates a tight turning radius, this factor may weigh in favor of concluding that the motor conveyance is a relatively small vehicle (or walking), rather than a larger vehicle.

It should be noted that, in many cases, certain of the data dimensions discussed above may provide useful information from which the system can draw conclusions, while other data dimensions may not. Merely by way of example, if the information collected by the mobile device does not indicate that the user has performed any tight radius turns, that data dimension may not provide useful information for the present trip, and/or the data dimension may be ignored in calculating the Bayesian probabilities regarding the user's mode of conveyance. Similarly, FIG. 8 depicts, for purposes of illustration, several exemplary data dimensions that can be evaluated in accordance with various embodiments, but it should be appreciated that other embodiments may track and/or evaluate data along different dimensions, and that FIG. 8 should not be considered limiting.

Optionally, the system may adjust the Bayesian rules (block 870). Merely by way of example, the system may change the weights given to various vehicles by a particular Bayesian rule, if the empirical data shows that the current weights conflict with conclusions drawn based on one or more other Bayesian rules.

At block 875, the system identifies the vehicle (or other mode of conveyance) that is most likely to be the user's mode of operation for the current trip. For example, as noted above, the system may apply the Bayesian rules progressively in order to develop, limit, and/or expand the list of possible options for the mode of conveyance until the system has arrived in a single option that appears to be the most likely. As another example, the system might combine data dimensions to evaluate the probabilities (as in the example above, where the direction of travel, location relative to the nearest road, and speed can be considered collectively). Optionally, the system may present the identified option to the user for confirmation.

At this point, the system has identified the current vehicle (or other mode of conveyance), and at block 880, the system can calculate performance statistics (e.g., carbon emissions data) based on the identified mode of conveyance, for example as described above. Thus, it should be noted, position and/or time information collected by the mobile device can be used for multiple purposes simultaneously (e.g., to identify the vehicle as well as to get good performance statistics for the vehicle). It should be further noted that the method 800 may be performed iteratively and/or a continuous basis during a trip, such that the identification of the most likely vehicle can be updated and/or modified as more information becomes available.

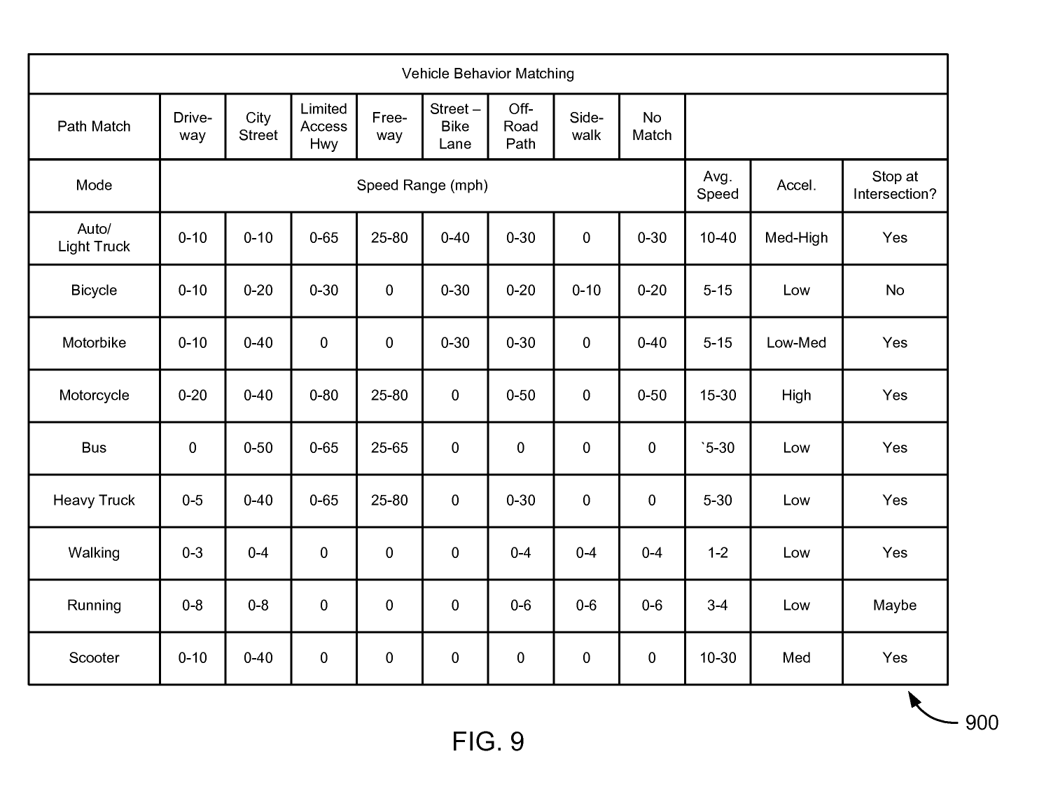

In an aspect, a plurality of Bayesian rules may be characterized as a matrix of options. For example, FIG. 9 illustrates one such matrix 900, with a variety of vehicles listed on the vertical axis of the matrix) and a variety of different locations (paths) listed on the horizontal axis of the matrix 900. Each cell in the matrix 900 comprises information about probably speed ranges for the corresponding vehicle and location (a speed range of 0, in the illustrated embodiment, indicates that the given vehicle would not be expected on that path/location). From the location and speed information obtained by the mobile device, the system can eliminate some possible options (or discount the weight of the probability of that option). These selections can be further refined by taking into account information about the average speed of the vehicle, the acceleration of the vehicle, and whether the vehicle stops at intersections, as indicated on the matrix 900.

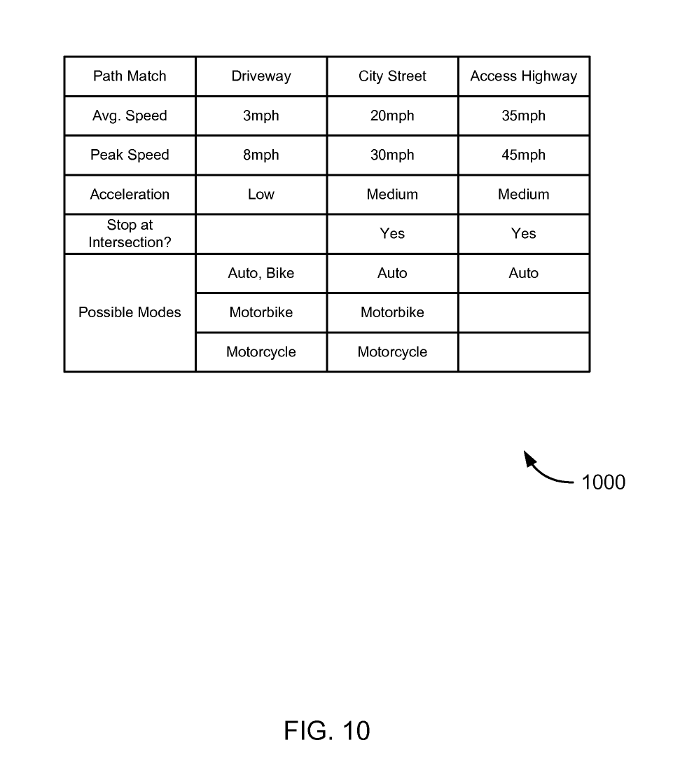

Applying this matrix to a specific trip, the system can rule out possible options until a most likely mode of conveyance has been identified. For example, the matrix 1000 of FIG. 10 shows an application of the matrix 900 to a specific set of data, which indicates that the user's trip included three paths/locations, with corresponding data: a driveway, on which the average speed was 3 miles per hour (“mph”), the peak speed was 8 mph, the acceleration was low, and the user stopped at stop signs; a city street, on which the average speed was 20 mph, the peak speed was 30 mph, and the acceleration was medium; and an access highway, on which the average speed was 35 mph, the peak speed was 45 mph, and the acceleration was medium.

From evaluating the data for the driveway path/location, the system identifies an auto, a bicycle, a motorbike (e.g., a motorized bicycle), and a motorcycle as possible options. Based on a further evaluation of the data for the city street path/location, the system can rule out a bicycle (because the acceleration data and the start/stop data does not match the parameters for a bicycle), and a further evaluation of the data associated with the access highway allows the system to conclude that an auto is the most likely mode of conveyance (as indicated by the average/peak speed and acceleration data).

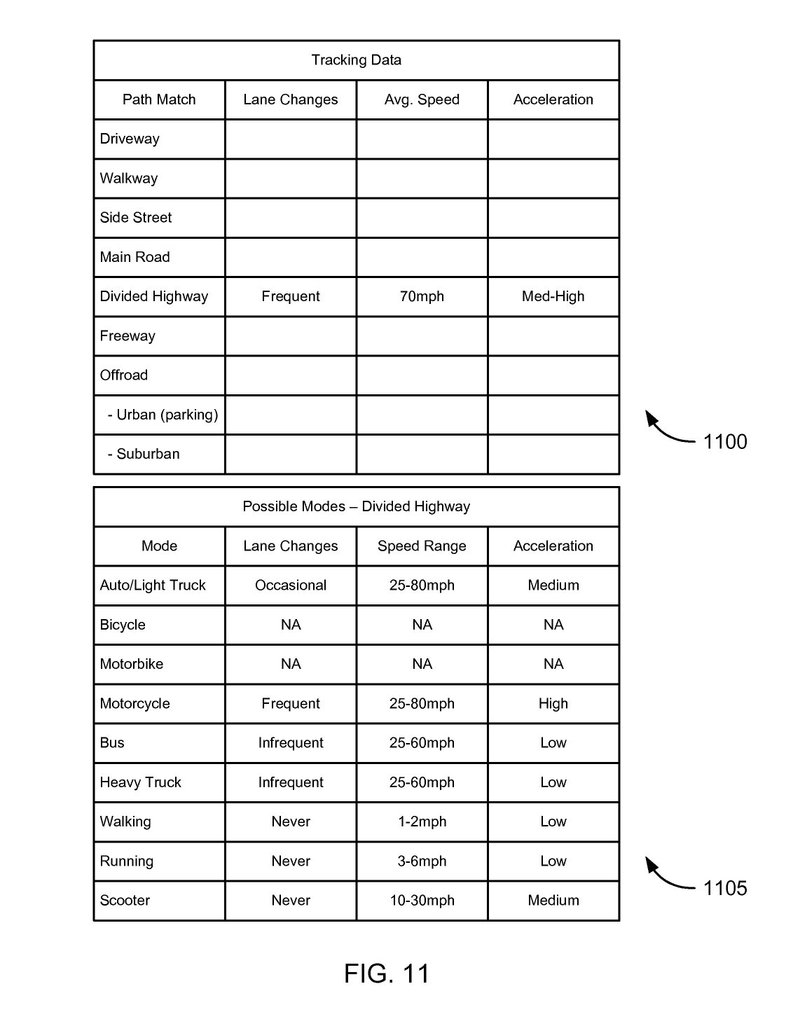

As another example, FIG. 11 illustrates a matrix 1100 describing a tracked vehicle's behavior, as well as a portion of a matrix 1105 showing possible behaviors for different modes of conveyance. (For ease of illustration, in this example, the vehicle's tracked locations all correspond to a divided highway, and the portion of the matrix 1105 is limited to that type of location, although it should be appreciated that a complete matrix might include other possible locations as well.) In this case, the collected position/time information indicates that the vehicle has been traveling an average of 70 mph, with medium to high acceleration and frequent lane changes. By comparing this data with the probability matrix, the system can determine that the vehicle is most likely a motorcycle, although it might also be an auto or a light truck. In the absence of other data, the system might conclude that the vehicle is a motorcycle; alternatively, the system might analyze other factors, such as past trip histories, etc., to identify a most likely mode of conveyance. Additionally and/or alternatively, the system might further analyze these data dimensions based upon additional data collected at a later time to re-assess the conclusion that a motorcycle is the most likely mode of conveyance.

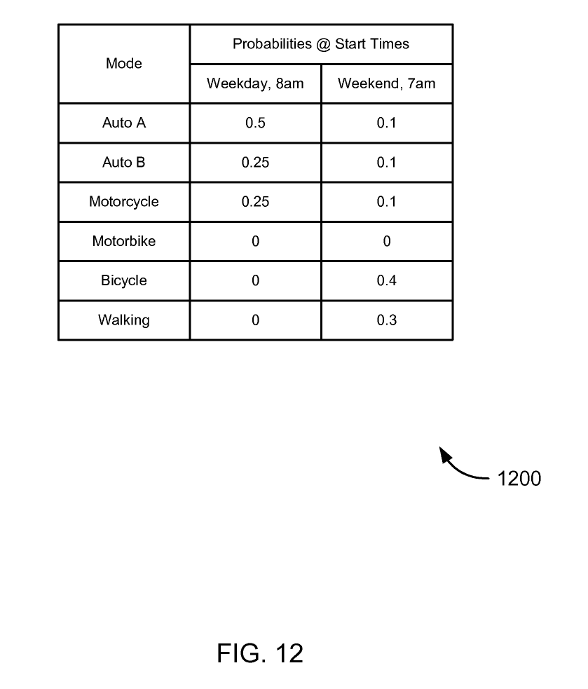

FIG. 12 illustrates a matrix 1200 of probabilities for a list of possible conveyance options for an exemplary user. The matrix 1200 may be developed, for example, based on past trip history data for that particular user, who might travel to work every weekday around 8:00 am. Historically, the user takes Auto A to work about half the time, takes Auto B about a quarter of the time, and takes his motorcycle to work the rest of the time. Historically, the user also frequently takes early-morning walks and bicycle rides on the weekend, with an occasional car or motorcycle trip in the morning on weekends as well.

Based on this historical data, the system assigns a probability coefficient of 0.5 to Auto A on weekday start times of 8:00 am and 0.1 for weekend start times of 7:00 am (in certain embodiments, the system will approximate these start times by any appropriate amount). Similarly, respective probability coefficients of 0.25 and 0.1 are assigned to both Auto B and Motorcycle, while probability coefficients of 0.4 and 0.3 are assigned to 7:00 am weekend start times for the Bicycle and Walking, respectively. These probability coefficients can be used as part of a Bayesian rule when evaluating a user's behavioral data to identify a mode of conveyance (as described with respect to FIG. 8, for instance). Based on this example, one skilled in the art can appreciate how probability coefficients can be applied to different start times (and/or to different data dimensions altogether), for use in a Bayesian analysis.

In some embodiments, the system can also use “fuzzy logic” processes. Merely by way of example, fuzzy logic processes can be used in conjunction with a Knowledge Base such as can be constructed from a series of data points collected from the traveling user's mobile device. The Knowledge base might comprise the location points visited or traversed by the user in one or more particular modes of conveyance. After a sufficient number of trips, patterns of the user's behavior can be identified and “mined” for suggested activities undertaken in the future, which may be predicted or inferred by either Bayes' methods or fuzzy logic methods. Various methods for deriving fuzzy logic outputs have been developed, including merely by way of example the Fuzzy Logic Toolbox™, commercially available from The MathWorks, Inc.™.

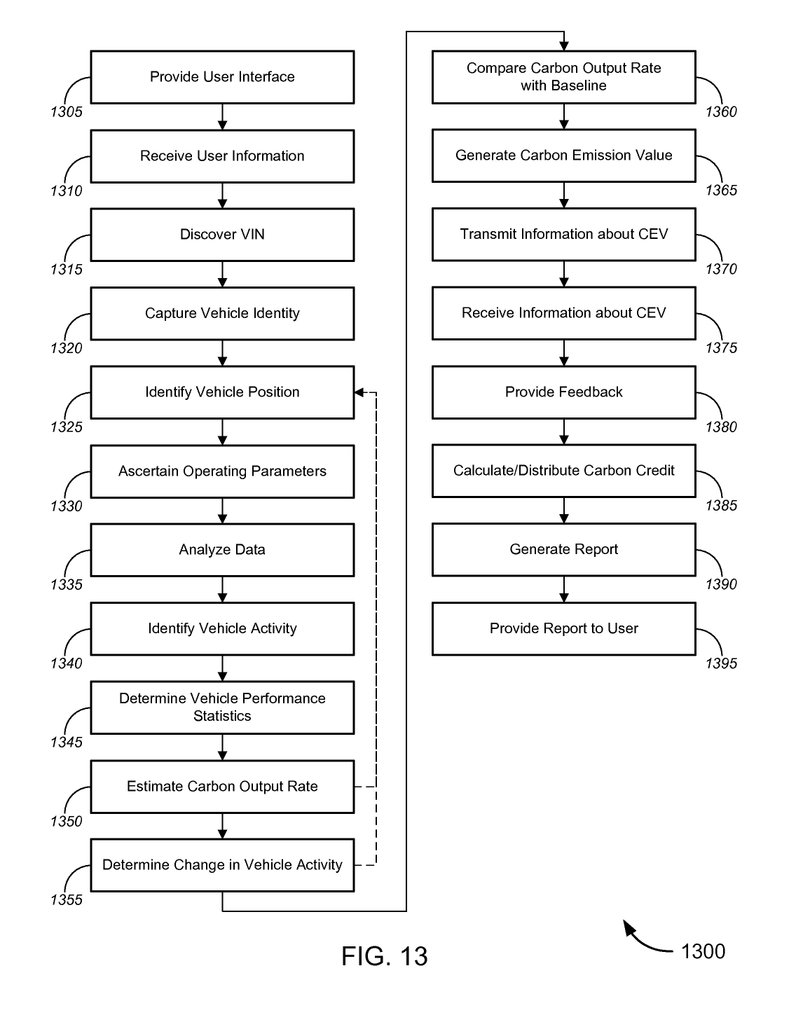

FIG. 13 illustrates a method 1300 of tracking carbon output from a vehicle. It should be noted, as an initial matter, that the method 1300 can be implemented in conjunction with, and/or can incorporate, procedures described above with respect to methods in accordance with other embodiments. It should also be noted that the method 1300 can be performed iteratively (either seriatim or in parallel) to track carbon output for multiple vehicles (e.g., multiple vehicles operated by a particular user, multiple vehicles in a fleet of vehicles, and/or the like.

The method 1300 comprises providing a user interface (block 1300), which can allow interaction between the user and various system components (e.g., a mobile device, tracking server, etc.), each of which can be considered a computer system (and which also collectively can be considered a computer system comprising multiple computers). For example, the user interface can be used to output information for a user, e.g., by displaying the information on a display device, printing information with a printer, playing audio through a speaker, etc.; the user interface can also function to receive input from a user, e.g., using standard input devices such as mice and other pointing devices, touch screens, keyboards (both numeric and alphanumeric), microphones (e.g., receiving voice commands and/or dictation), etc.

The procedures undertaken to provide a user interface, therefore, can vary depending on the nature of the implementation; in some cases, providing a user interface can comprise displaying the user interface on a display device; in other cases, however, where the user interface is displayed on a device remote from a computer system (such as on a client computer, mobile device, etc. that is remote from, e.g., a tracking server), providing the user interface might comprise formatting data for transmission to such a remote device and/or transmitting, receiving and/or interpreting data that is used to create the user interface on the remote device. Conversely, providing a user interface might comprise, displaying, on such a remote device, the information received from the server (and/or transmitting user input to be received by the server).

Alternatively and/or additionally, the user interface on a client computer (or any other appropriate user device) might be a web interface, in which the user interface is provided through one or more web pages that are served from a computer system (such as a server computer and/or a web server in communication with the server computer), and are received and displayed by a web browser on the client computer (or other capable user device). The web pages can display output from the computer system and receive input from the user (e.g., by using Web-based forms, via hyperlinks, electronic buttons, etc.). A variety of techniques can be used to create these Web pages and/or display/receive information, such as JavaScript, Java applications or applets, dynamic HTML and/or AJAX technologies.

In many cases, providing a user interface will comprise providing one or more display screens, each of which includes one or more user interface elements. As used herein, the term “user interface element” (also described as a “user interface mechanism” or a “user interface device”) means any text, image or device that can be displayed on a display screen for providing information to a user and/or for receiving user input. Some such elements are commonly referred to as “widgets,” and can include, without limitation, text, text boxes, text fields, tables and/or grids, charts, hyperlinks, buttons, lists, combo boxes, checkboxes, radio buttons, and/or the like. While the exemplary user interfaces described herein employ specific user interface elements appropriate for the type of information to be conveyed/received by computer system in accordance with the described embodiments, it should be appreciated that the choice of user interface element for a particular purpose is typically implementation-specific and/or discretionary. Hence, the illustrated user interface elements employed by the user interfaces described herein should be considered exemplary in nature, and the reader should appreciate that other user interface elements could be substituted within the scope of various embodiments.

As noted above, in an aspect of certain embodiments, the user interface provides interaction between a user and a computer system. Hence, when this document describes procedures for displaying (or otherwise providing) information to a user, or to receiving input from a user, the user interface may be the vehicle for the exchange of such input/output. Merely by way of example, in a set of embodiments, the user interface allows the user to input vehicle information, view vehicle performance statistics, view reports, and/or the like.

The method 1300 further comprises receiving user information (block 1310). In one aspect, user information can comprise user input and/or can be received via a user interface. The user information can comprise any of a variety of different types of information that might help the system to identify the user and/or the user's vehicle. Merely by way of example, in some embodiments, the user information might include user authentication credentials, such as userid/pas sword. In other embodiments, the user information might include a device-specific identifier for a mobile device operated by the user. In further embodiments, the user information might include identification of a vehicle to be tracked (and/or other vehicle information, from which a vehicle identity can be determined by the system), which may be provided by user input, interrogation of vehicle computer systems, and/or the like. In some embodiments, user information can include user input about system functionality that the user would like to use, such as user preferences, desired functions (e.g., a carbon tracking function), and/or the like.

The method 1300 might comprise discovering a VIN of the vehicle being operated by the user (block 1315), or otherwise discovering identifying information about the vehicle. A variety of techniques can be used to discover the VIN of the vehicle. Merely by way of example, in some cases, the user information might include the VIN, such that discovering the VIN might merely comprise receiving and/or parsing the user information. As noted above, in some embodiments, the system maintains a database of vehicle information, which may be correlated with user information. Hence, in some situations, for example if the user has registered only a single vehicle, the VIN can be ascertained from the user's identity. In yet other embodiments, discovering the VIN might comprise interrogating the vehicle's electronic systems to identify the VIN (or other information from which the VIN can be identified) and/or otherwise receiving the VIN from the vehicle's electronic systems (which can include, without limitation, the vehicle's diagnostic systems). Other options exist as well. For instance, if the user has identified the vehicle in some fashion without using the VIN (for example, by providing the year, make and/or model of the vehicle), the system may discover the VIN by looking up all vehicles registered with the system by that user to find a vehicle that matches the identified vehicle, and/or by obtaining the VIN from the registration of that vehicle with the system. Alternatively and/or additionally, the system might search an external system (such as a database operated by a state motor vehicle department or other governmental agency, an insurance company database, and/or the like) to find a vehicle associated with the user and matching any identifying information provided by the user.

In some embodiments, the method 1300 comprises capturing an identity of the vehicle being operated by the user (block 1320). In one aspect, capturing the identity of the vehicle can comprise identifying the vehicle. In another aspect, capturing the identity of the vehicle can comprise storing a record of the vehicle's identity in order to associate any subsequent performance statistics collected and/or measured by the system (e.g., during a particular trip) with the identified vehicle. In some cases, the identity of the vehicle may be determined from the previously-discovered VIN. In other cases, the VIN may not be needed, and/or the identity the vehicle may be ascertained and/or recorded more informally, such as a nickname provided by the user, the vehicle's make and/or model, etc.

As noted above, in certain embodiments, an inference manager (such as the HIM described above) can be employed to capture the identity of a vehicle, based on any of a number of factors. Merely by way of example, a map-matching algorithm can be used to infer the identity of the vehicle based on the vehicle's location (e.g., relative to a road), speed, acceleration, driving behavior, past trips, the start time of the present trip, and/or other applicable factors.

Thus, in an aspect, capturing a vehicle's identity can comprise capturing and/or recording any sort of information by which the vehicle can be identified for tracking purposes. More particularly, in some cases, as described in further detail herein, the nature of the vehicle and/or various operating characteristics thereof may be important for determining and/or tracking performance statistics, and in such cases, a precise identification of the vehicle may be necessary or desirable; in other cases, however, such precise identification may not be necessary. For example, if the user has provided a vehicle nickname and actual fuel consumption statistics can be recorded for the vehicle (from user input comprising fuel purchase information, from fuel tank and/or injector sensors, etc.), the nature and/or other characteristics of the vehicle may not be a necessary component of the vehicle's identity.

The method 1300 might further comprise identifying a vehicle position (block 1325). In some cases, the position may be identified in two dimensions, while in other cases, the position may be identified in three dimensions (e.g., to allow tracking of vehicle altitude changes, which can have a significant effect on certain performance statistics). Various techniques for identifying the vehicle position are described in further detail above, and can include, merely by way of example, receiving GNSS position information, triangulating position based on signals received from one or more wireless transmitters on cellular networks, Wi-Fi networks, and/or the like. As noted above, in an aspect, each vehicle position fix may be accompanied by a matching timestamp, which can be provided through the GNSS signal, from a clock on a mobile device, and/or a clock at a tracking server (e.g., upon receiving position information), to name a few examples. Also as noted above, the operation of receiving vehicle position and/or time fixes may be performed iteratively and/or continuously, in order to provide and/or derive path data, velocity data, acceleration data, and/or any other necessary data. Hence, in one aspect, the method 1300 can comprise capturing a first position of the vehicle at a first time, and capturing a second position of the vehicle at a second, subsequent time.

At block 1330, the method 1300 comprises ascertaining a set of one or more operating parameters of the vehicle, which can include any information about the operation of a vehicle that might be relevant to the calculation or estimation of a vehicle's performance statistics (including, in particular, the vehicle's carbon output rate). Several exemplary operating parameters are described above, any they can include, without limitation, fuel consumption (e.g., an amount of fuel consumed per unit of distance driven), engine speed (RPM), operating gear level and/or gear ratios, vehicle position, change in altitude, movement direction and/or velocity, etc.

Various embodiments can employ different techniques to ascertain such operating parameters. Merely by way of example, in one embodiment, a mobile device might receive location information from a GNSS receiver, which could either be external or internal to the wireless device. From this position information (and associated time information), vehicle direction and velocity (and/or a velocity vector) can be calculated. Both the position information and the velocity information can be considered operating parameters.

In another embodiment, a mobile device might receive vehicle operating data (comprising one or more operating parameters) from a vehicle's onboard systems (e.g., navigation systems, OBD systems, trip computers, etc.). Such data might include, without limitation, fuel consumption data (e.g., from a fuel tank monitor, fuel injector sensors, etc.), engine RPM, vehicle speed, emissions information, and/or the like. All of this data can also be considered to be operating parameters.

Hence, ascertaining or identifying operating parameters can comprise, without limitation, sensing data related to those parameters, receiving such data (either at a mobile device and/or at a server in communication with the mobile device) from a vehicle and/or another information source (e.g., a GNSS receiver, other position determination devices, etc.), and/or calculating/deriving operating parameters from sensed/received data. One skilled in the art should appreciate, based on the disclosure herein, that there are a wide variety of operating parameters that might be ascertained/identified, and that any appropriate techniques may be used to perform these operations.

The method 1300 can further comprise analyzing the available data (block 1335). Often, the available data will include the ascertained vehicle operating parameters. The available data might also include data additional to vehicle operating parameters. For example, in some cases, the analysis of the available data will include analysis of the data with an inference manager, such as the HIM described above. In such cases, the available data might include not only position information about the vehicle's position (and associated time data, derived velocity/acceleration data, etc.), but also geographical information (from which the vehicle's location relative to a road can be determined), historical path information, behavioral information and/or other information about a user of the vehicle, and/or any other data that might be used as input to the inference process (for example, as described above).

At block 1340, the method 1300 comprises identifying a vehicle activity. Identifying a vehicle activity can comprise determining a state of the vehicle that can then be used to calculate, derive, and/or estimate performance statistics of the vehicle based on that activity. For example, the system might identify the vehicle activity as driving at 55 mph on a flat road, and from that information, along with the identity of the vehicle (which can provide the vehicle's fuel economy, for example) and/or any other relevant information (e.g., current altitude, engine RPM, etc.), the system can determine (e.g., calculate and/or estimate) the vehicle's fuel consumption at that time. In one aspect, the system identifies the vehicle's activity over a certain period (interval) of time. Merely by way of example, the activity between the times associates with two identified positions of the vehicle, or between two sample times of other operating parameters. This identification, therefore, can be done iteratively over the course of a vehicle's trip, to provide granular identification of the vehicle's activities at different times.

Often, the identification of the vehicle activity is based on the analysis of the available data. Merely by way of example, if the analysis of the available data includes performance of an inference process, the result of that inference process can identify the vehicle's activity. As another example, if the analysis of the data indicates that the vehicle was at different points on the same road at a first time and a second time, the vehicle's activity might be identified as driving on that road (at a speed calculated from the relative positions and times).

The method 1300, in an embodiment, further comprises determining one or more vehicle performance statistics (block 1345). In some cases, vehicle performance statistics can be directly calculated, while in others, the performance statistics are estimated (based on what data is available for analysis) and/or looked up from a database (e.g., based on the identity of the vehicle and one or more measured operating parameters, such as vehicle velocity, etc.). In either case, the result of the process is similar. Based on the identified vehicle activity, and/or other data (such as operating parameters), the system determines the appropriate performance statistics. Performance statistics can include any of a variety of statistics (such as top speed, average speed, miles driven, to name but a few), but most particularly, such statistics can include fuel consumption and/or atmospheric carbon output. For example, as noted above, for a particular vehicle, fuel consumption statistics can be compiled under a variety of operating conditions (corresponding to various vehicle activities), and once the vehicle and activity are identified, the fuel consumption of the vehicle undertaking that activity can be looked up, calculated, derived, and/or otherwise determined.

Hence, in accordance with certain embodiments, the method 1300 comprises estimating a carbon output rate of the vehicle (block 1350). In many cases, this estimation is based on the identity of the vehicle and one or more operating parameters of the vehicle for a particular vehicle activity (which together can be used to calculate or estimate, for example, fuel consumption during the course of that activity, from which carbon output can be derived). As noted above, and in the attached Appendix, there are a variety of techniques, ranging from fairly simple to quite sophisticated, for estimating atmospheric carbon output. Any appropriate technique, including those described above and in the Appendix, may be used to estimate a carbon output rate of the vehicle. In an aspect, for example, once the fuel consumption of a vehicle has been determined over a particular period (based on the activity of the vehicle over that period), the nature of the vehicle's fuel (e.g., diesel fuel, automotive fuel, etc.) can be identified based on the vehicle's identity, and the amount of atmospheric carbon (and/or carbon equivalents) output can be estimated based on the rate of fuel consumed and the type of fuel.

The method 1300 might loop back to block 1325, in which the vehicle position is identified, either because the system has determined that the vehicle activity has changed (block 1355) or merely to continue the process to estimate vehicle performance statistics (e.g., fuel consumption, carbon output, etc.) for one or more subsequent periods. For example, in a particular embodiment, the system might determine that a vehicle has changed activities after receiving a position fix (which could indicate, for example, that vehicle velocity has decreased), at which point the system reiterates the process to find a carbon output rate for this new activity. The length of a particular measurement period is not limited, and it can be as short as a fraction of a second or as long as several minutes or hours, depending on the embodiment and the nature of the vehicle's activities. In one aspect, multiple periods over which the vehicle engages in a single activity (such as long drives on an open freeway) might be consolidated into a single period, although this is not required.

In some embodiments, the method 1300 might comprise comparing the carbon output rate with a baseline carbon output rate (block 1360). This baseline rate might be specific to a particular vehicle or type of vehicle (such as the vehicle currently operated by the user). In such cases, comparison of the estimated carbon output rate for the vehicle with the baseline carbon output rate can provide some indication whether the user's operation of the vehicle (e.g., driving speed, acceleration habits, route, etc.) are producing more or less carbon output than would be expected of a typical driver of the same vehicle. In other cases, the baseline rate might be more generic (e.g., for certain class of vehicle, for all consumer vehicles, etc.) and/or might be specific to the type of vehicle activity that has been identified by the system. This type of analysis can inform the user about how the user's carbon output rate is affected by the user's vehicle selection. In other cases, for example, more specific baseline rate might be used. For instance, the user could be given the option to select a particular vehicle and/or type of vehicle (e.g., a hybrid-fueled vehicle) as a baseline, and the system could compare the user's actual carbon output rate with a hypothetical carbon output rate based on a baseline carbon output rate for the selected vehicle.

At block 1365, the system can generate a carbon emission value (“CEV”) for the measurement period. In an aspect, the carbon emission value is based upon the vehicle's carbon output rate over one or more periods. Merely by way of example, a carbon emission value for a particular period may comprise the carbon output rate for that period, multiplied by the length of the period, to produce a result that indicates the amount of carbon output for the period. Further, the carbon emission value for a particular trip can be calculated by summing the carbon emission values for each period over the course of the trip. Similarly, the carbon emission value for an interval of time (e.g., a week a month, etc.) can be determined by adding the carbon emission values of all trips during that interval.

In other embodiments, the carbon emission value might be relative to a baseline and/or another value. Thus for example, a carbon emission value of 1.5 might indicate that the user's carbon output rate is 50% greater than the baseline rate (for the same vehicle, for another vehicle to which the user seeks comparison, etc.) over the course of a particular period, trip, etc. Thus, it should be appreciated, that the carbon emission value can take one or more of any of these forms in order to provide the most useful information.

In different embodiments, various system components can be used to perform various operations of the method 1300. Merely by way of example, in some cases the identification of the vehicles activity (or any other appropriate operations) may be performed locally, e.g. a mobile device operated by the user in or around the vehicle. In fact, in certain embodiments, the mobile device may perform some or all operations of the method 1300, and/or the tracking server may be unnecessary.

In other embodiments, however, the use of the tracking server may be desirable and/or necessary. For example, a mobile device may not have sufficient data storage capabilities and/or processing capabilities to undertake all of the necessary operations. Accordingly, some or all of these operations may be performed at tracking server. For instance, in one embodiment, the mobile device might collect position and/or time information locally at the vehicle and/or might transmit that information to a tracking server. The tracking server, upon receiving the position and/or time information, could then analyze that information to identify the vehicle activity. Similarly, in other embodiments, the mobile device might collect and/or receive other data, including without limitation, vehicle operating parameters, and transmit that data, or a portion of the data, to the server for analysis. The server could then analyze the received data, identify vehicle activities, determine necessary performance statistics, perform baseline comparisons, and/or transmit any necessary output back to the mobile device.

Hence, in some embodiments, one system component might transmit information about the carbon emission value (or any other vehicle performance statistic) to another system component (and/or to a user) (block 1370), which receives the information about the carbon emission value (block 1375). Merely by way of example, in an embodiment that employs a server to provide analysis and/or calculation, the server might transmit the results of the analysis and/or calculation (e.g., the carbon emission value, other performance statistics, etc.) back to a mobile device from which the vehicle operating parameters were received. In other embodiments, one server might transfer such data to another server for storage, user interaction, further analysis, regulatory and/or market reporting, and/or the like.

In some embodiments, the system provides feedback to a user (block 1380). In accordance with different embodiments, a wide variety of feedback mechanisms may be employed. Merely by way of example, in a system employing a mobile device user interface of the mobile device can be used to provide feedback to the user. Additionally and or alternatively, such feedback may be provided in a variety of other forms, including without limitation, by posting such feedback on a website, portal, blog, microblog, etc.; by transmitting the feedback via e-mail, printout, text message short message service (“SMS”) message, multimedia message service (“MMS”) message, and/or the like; and/or using any other appropriate mode of communication.

For instance, the user interface of a mobile device can be used to provide visual and/or audible feedback in real time (and/or near real-time) about a user's carbon output rate, carbon emission value, and/or any other vehicle performance statistics. By way of example, the mobile device might provide a frequently updated numerical display of the user's vehicle's current carbon output rate and/or carbon emission value. Alternatively and/or additionally, if the vehicle's current carbon output rate exceeds a baseline rate, the mobile device might provide an audible warning, such as one or more tones (e.g., a tone at a first pitch to indicate that the carbon emission value is below a baseline value and a tone at a second pitch to indicate that the carbon emission value is above the baseline value), spoken warnings or other voice prompts (e.g., a spoken indication that carbon emission value is above baseline, a spoken representation of a numerical carbon emission value, etc.), and/or the like, and/or might modify the display (using different colors, flashing images, and/or the like) to provide such indication.

As another example, the feedback might comprise a graphical illustration depicting one or more vehicle performance statistics. For instance, the user interface of the mobile device can provide a rolling graph illustrating the user's current carbon output rate along with the baseline rate, to show when the user is at, above, or below the baseline rate. As another example, the feedback might merely comprise a colored indicator corresponding to the user's current carbon output rate and/or carbon emission value (e.g., green for a carbon output rate below the baseline rate, yellow for a carbon output rate at the baseline rate, or red for a carbon output rate above the baseline rate).

In some cases, the method 1300 further comprises calculating and/or distributing an amount of carbon credit corresponding to the carbon emission values of one or more vehicles. Merely by way of example, some embodiments provide carbon tracking for a plurality (i.e., a fleet) of vehicles, as described in further detail herein. In one aspect, a fleet of vehicles might be a corporate fleet, comprising a plurality of vehicles owned and/or operated by a corporation, family, or other entity. In anther aspect, a fleet of vehicles might comprise a plurality of vehicles with different owners; in an aspect, these owners might share one or more common demographic characteristics, which can include geographical characteristics (e.g., where the owners/operators live, travel, etc.), vehicle characteristics (e.g., a make and/or model of vehicles), and/or the like. To provide but one example, a fleet of vehicles might comprise all the vehicles owned and/or operated in a particular neighborhood, city, state, and/or country.

Accordingly, the method 1300 might comprise calculating an overall amount of carbon credit corresponding to a carbon emission value of one or more vehicles (which might be, in a specific case, a carbon emission value for a fleet of vehicles). Various techniques of calculating a carbon credit might be used, but it is anticipated that, certain techniques will perform a calculation (either on a per-vehicle or per-fleet basis) that takes into account the actual carbon emission value(s) for the vehicle (or each vehicle in the fleet), as well as regulatory standards (which might specify a per-vehicle and/or per-fleet carbon allowance), and the carbon credit corresponding to the carbon emission value for the vehicle/fleet can be calculated as a differential between the allowance value and the actual carbon emission value.

Alternatively and/or additionally, the system might generate a report (block 1390) and/or provide that report to a user (block 1395). In one aspect, such a report can be viewed as one type of feedback that can be provided to the operator of the vehicle. In another aspect, however, the report may be more general and/or may be generated for another user (e.g., a fleet manager, a fleet owner, a carbon credit trading exchange, etc.).

In some embodiments, generating a report might comprise compiling vehicle performance statistics (including without limitation carbon output rate, carbon emission value, fuel consumption, fuel economy, etc.) for a particular trip and/or interval of time. In an aspect, the report may include information about baseline carbon emission values/rates. Merely by way of example, the report might list the user's carbon output for a particular interval of time, along with a baseline carbon output for the same interval, optionally with an indication of when the user's output was above and/or below the baseline. This information can be provided numerically and/or graphically. Similarly, in some cases, the report might compare the user's carbon output over one interval with the user's carbon output over another interval, e.g. to provide a historical comparison. (In an aspect, a vehicle's carbon output over one interval of time can be considered a baseline carbon output rate that can be compared to output over another interval of time and/or from another vehicle.)

In some cases, these statistics may be compiled for multiple vehicles (e.g., multiple vehicles operated by a user or family of users, multiple vehicles within a fleet of street vehicles and/or construction vehicles, etc.). In an aspect, generating the report comprises calculating a carbon emission value for each of the vehicles in the report and/or an overall carbon emission value for the group/fleet of vehicles.

An exemplary report might comprise tabulated results, categorized by vehicle. For instance, a first set of results for first vehicle may comprise a list or table showing each trip during the interval of interest, along with a carbon emission value for that trip. Each entry might include various information about the trip, such as insert time of the trip, a path of the trip (e.g. starting and stopping locations), any identifier of the trip assigned by the user (e.g., “Spring break ski trip”), and/or the like. This list/table but also include a summary line (e.g., at the bottom of the list/table) showing a total carbon emission value for that vehicle for the interval. The report might comprise other lists/tables further vehicles in the group/fleet, formatted in similar fashion.

Providing the report to a user can comprise one or more of several operations. In some cases, the report may be provided using the feedback techniques described above (e.g., transmitting the report to a mobile device, transmitting the report via electronic mail, displaying the report on a web site/portal, and/or the like). In some cases, the system might provide a specialized user interface for vehicle operator and/or a fleet manager (via a webpage, dedicated application, and/or the like), and the report can be provided via that user interface. In other embodiments, the report may be provided in written format, e.g., as a printout, via postal mail, and/or the like.

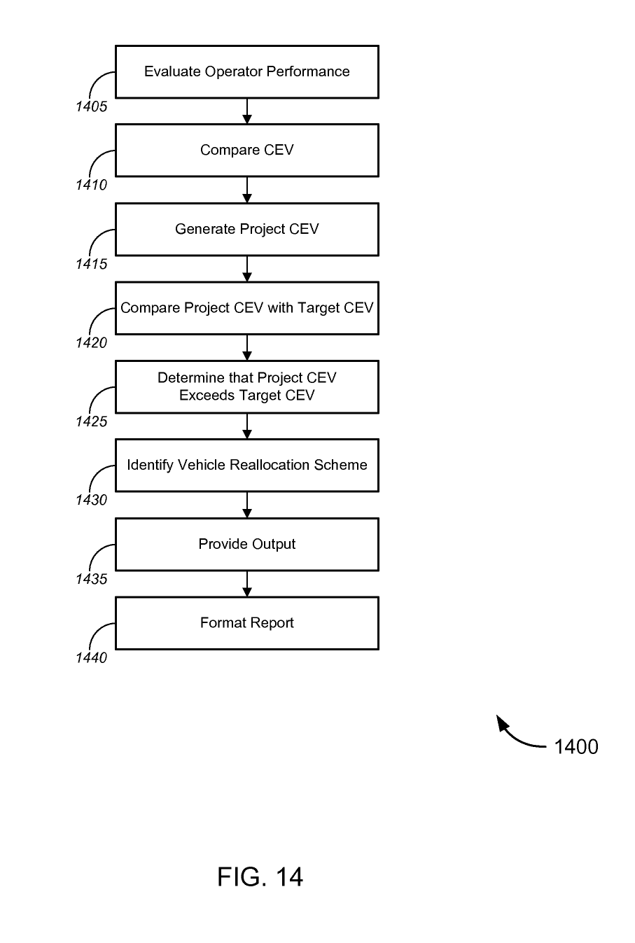

FIG. 14 illustrates a method 1400 that can be used to track performance statistics (such as carbon output, to name one example) for a plurality of vehicles. One example of such a plurality is a fleet of street vehicles (such as delivery vans, repair vans, and/or the like). Another example is a fleet of construction equipment (which can include a variety of heavy equipment, such as bulldozers, graders, and/or the like, as well as lighter vehicles, such as heavy-duty pickup trucks, etc.). In the fleet context, the method 1400 can allow a manager to monitor carbon output (or any other appropriate vehicle performance statistic) across the fleet, make adjustments to fleet utilization, compare various fleet operators, etc. For an individual user, the method 1400 can allow the user to evaluate the environmental impact of multiple vehicles in the user's garage, make prospective decisions on which vehicle to use for particular trips, and/or the like. For both types of users, the method 1400 can enable and/or facilitate any tracking or reporting that might be required by regulatory bodies, carbon trading markets, and/or the like.

In an aspect, the method 1400 assumes that carbon emission values (or other vehicle performance statistics) have been determined, over one or more intervals of time, for each of the vehicles in the plurality of vehicles to be monitored. A process, which might include some or all of the operations described with respect to the method 1300 of FIG. 13, can be used to generate this data. In some cases, certain of those operations may be modified somewhat to allow for the possibility that different operators might operate the vehicles in the group/fleet. Merely by way of example, when collecting user information at block 1310, the system might collect operator information (e.g., each operator might have a separate set of authentication credentials) and/or store that operator information along with the vehicle information (at least for that particular trip), so that the identity of the operator can be used as an input to some of the operations in the method 1400. Similarly, the user information might include a project identifier (e.g., in the case of a construction fleet), so that carbon emissions for a particular trip or task can be attributed to the appropriate project.

The method 1400, in an embodiment, comprises evaluating the performance of an operator of one or more of the vehicles in the plurality of vehicles (block 1405). In some cases, the evaluation of the performance of an operator of a vehicle might comprise comparing a carbon emission value of vehicles driven by that operator with another carbon emission value (block 1410). For instance, in some embodiments, an operator's performance can be evaluated against the performance of another operator by comparing a carbon emission value of a vehicle operated by that operator with a carbon emission value of a vehicle operated by a different operator. (In some cases, the vehicles may be similar vehicles, or in fact the same vehicle operated by each operator at different times, to provide for a more valid comparison.) In this way, for example, the performance of one operator can be compared against the performance of another operator based on the comparison of the carbon emission values of the operators' respective vehicles. In other embodiments, the operator's performance can be evaluated by comparing the carbon emission value of the vehicle operated by that operator with a baseline carbon emission value, which may be based on historical operations of the vehicle (or similar vehicles) by other operators, and/or any other relevant factors.

At block 1415, the method 1400 comprises generating a project carbon emission value. As noted above, in some cases, one more vehicles may be associated with a project, such as a construction project on a road, building, and/or the like. In such cases, a carbon emission value for the project can be generated. In aspect, the carbon emission value for the project may be the sum of the carbon emission values for the vehicles involved in the project (at least when performing tasks in furtherance of the project). Accordingly, in an aspect, generating a project carbon emission value can be accomplished by consolidating the carbon emission values for all of the vehicles (and/or trips/tasks) associated with that project. Additionally and/or alternatively, the project carbon emission value might include carbon emissions from non-mobile sources, such as asphalt mills, concrete pouring operations, refineries, bakeries, assembly plants, places of business, virtually any facility that consumes power by burning fuels or is a consumer of electric power, and/or the like.

In similar fashion, a fleet carbon emission value can be generated by consolidating (e.g., summing, averaging, etc.) the carbon emission values of individual vehicles within the fleet. Like individual carbon emission values, a fleet carbon emission value and/or project carbonation value may be generated for a particular interval of time, such as a week, month, etc. Alternatively and/or additionally, particularly in the case of a project carbon emission value, the carbon emission values of all vehicles involved with the project from beginning to end may be consolidated (with each other and/or with carbon emission values for non-mobile sources) to produce an overall carbon emission value for the project.

At block 1420, the project carbon emission value can be compared with a target project carbon emission value. A target project carbon emission value can be established in a variety of ways. Merely by way of example, in some cases a governmental regulatory body might establish carbon emissions restrictions for construction and other projects. These requirements might be vehicle-specific, and/or they might impose general requirements for the project overall (e.g. a limitation on total carbon emissions for the project, a limitation on average carbon emissions for each vehicle on the project, and/or the like). Alternatively and/or additionally, a company might wish to establish carbon output targets for its projects, either to be a good corporate citizen, to enable trading of carbon credits on carbon credit trading exchanges, etc.

Hence, comparing a project carbon emission value with a target project carbon emission value can comprise normalizing carbon emission values (for instance, to convert a per-vehicle carbon output limitation to an overall project carbon emission value, etc.) and/or evaluating the project carbon emission value to determine whether it exceeds the normalized target project carbon emission value.

If it is determined (based, for example, on a comparison of the project carbon emission value with the target carbon emission value) that the project carbon emission value exceeds a target project carbon emission value (block 1425), the method 1400 can comprise identifying a vehicle reallocation scheme (block 1430). Merely by way of example, a contractor may operate multiple construction projects simultaneously. Each of those projects may have a fleet of vehicles associated therewith. Project carbon emission values can be generated for each of the projects, based at least in part on the carbon emission values for each vehicle in each of the projects. Because the carbon emission values for each of the vehicles involved in the project are known, the system can reallocate vehicles with similar functionality between the two projects. (In this context, it should be noted that in some embodiments, a vehicle database might comprise a variety of information about a fleet of construction vehicles including, in addition to the information described above, performance statistics of each vehicle and/or functions performed by each vehicle, to allow the system to identify vehicles with similar functionality).

To illustrate, consider an example in which a contractor operates two construction projects. The first project has assigned to it several vehicles, including an aging front-end loader that has relatively poor fuel economy. The second project also has assigned to it a front-end loader, but this loader is relatively new, with a significantly more efficient engine and therefore higher fuel economy. If the first project has a carbon emission value that exceeds the target carbon emission value for that project, and the second project has a carbon emission value that is significantly lower than the target carbon emission value for that project, the system can reallocate the two front-end loaders, so that the more efficient front-end loader is assigned to the first project, thereby decreasing the carbon emission value for that project going forward. Conversely, the inefficient front-end loader is reallocated to the second project, raising the carbon emission value for that project going forward. Because the second project, however, has a carbon emission value below the target, the substitution of the inefficient front-end loader does not cause the project carbon emission value of the second project to exceed the target. This process can be performed iteratively for a variety of vehicles between two or more projects, in order to balance the carbon emission values of each project to meet each respective target carbon emission value. (Similar analysis can be undertaken, of course, by the system to automatically identify vehicles—including construction vehicles as well as other types of vehicles—that should be retired from a fleet in order to improve the overall carbon emissions of the fleet.)

At block 1435, the method 1400 comprises providing output for a user. The output provided to the user can depend upon the operations performed by the system. By way of example, if the system identified a reallocation scheme for one or more projects, the output might include a description of the one of more vehicles to be reallocated between the respective sets of vehicles assigned to each project, based on the reallocation scheme. In other cases, the output might comprise a report, which may be similar to the reports described above, and/or which may be generated on a fleet-by-fleet or project-by-project basis. Such a report may include project carbon emission values and/or fleet carbon emission values over specified intervals and/or overall project/fleet carbon emission values. Merely by way of example, a project carbon emission value report might provide feedback that indicates a relationship between one or more project carbon emission values and one or more target project carbon emission values (e.g., whether or not a project carbon emission value exceeds the relevant target value).

In a particular aspect, a report might provide a comparison of carbon emission values for two or more vehicles within a fleet of vehicles. In some cases, these vehicles might have a common (i.e., the same) make and model, so that a comparison can reveal suboptimal vehicle operating efficiency, differences in operator behavior, etc. In another aspect, the report may be provided by a user interface on a separate computer operated by the fleet manager, etc., as described above.

In a particular embodiment, the method 1400 can comprise formatting the report in a specified format (block 1440). For instance, if a regulatory (or other governing) body requires monitoring of a project's or a fleet's carbon emissions, formatting the report might comprise generating a report in the format required by the regulatory body's monitoring and/or reporting requirements. As another example, carbon credit trading exchanges often impose specific monitoring, verification, and reporting requirements in order to trade carbon credits, and formatting a report can comprise generating a report in the format required by such a carbon credit trading exchange. An example of one such carbon credit trading exchange is the Chicago Climate Exchange.

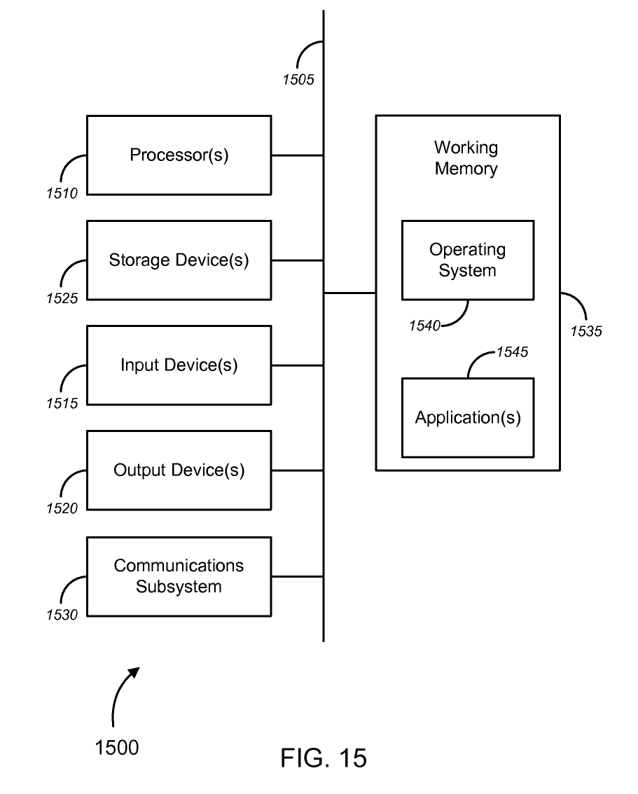

FIG. 15 provides a schematic illustration of one embodiment of a computer system 1500 that can perform the methods provided by various other embodiments, as described herein, and/or can function as a mobile tracking device, wireless device, other mobile device, server, user/client computer, and/or the like. It should be noted that FIG. 15 is meant only to provide a generalized illustration of various components, of which one or more (or none) of each may be utilized as appropriate. FIG. 15, therefore, broadly illustrates how individual system elements may be implemented in a relatively separated or relatively more integrated manner.

The computer system 1500 is shown comprising hardware elements that can be electrically coupled via a bus 1505 (or may otherwise be in communication, as appropriate). The hardware elements may include one or more processors 1510, including without limitation one or more general-purpose processors and/or one or more special-purpose processors (such as digital signal processing chips, graphics acceleration processors, and/or the like); one or more input devices 1515, which can include without limitation a mouse, a keyboard and/or the like; and one or more output devices 1520, which can include without limitation a display device, a printer and/or the like.

The computer system 1500 may further include (and/or be in communication with) one or more storage devices 1525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1500 might also include a communications subsystem 1530, which can include hardware for communicating with a vehicle's electrical systems (e.g., OBD systems, navigation computers, etc.), with other computers (e.g., servers, client computers, mobile tracking systems, etc.). Such hardware can include, without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 1530 may permit data to be exchanged with a network (such as the network described below, to name one example), with other computer systems, and/or with any other devices described herein. In many embodiments, the computer system 1500 will further comprise a working memory 1535, which can include a RAM or ROM device, as described above.

The computer system 1500 also may comprise software elements, shown as being currently located within the working memory 1535, including an operating system 1540, device drivers, executable libraries, and/or other code, such as one or more application programs 1545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a computer readable storage medium, such as the storage device(s) 1525 described above. In some cases, the storage medium might be incorporated within a computer system, such as the system 1500. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 1500 and/or might take the form of source and/or installable code, which, upon compilation and/or installation on the computer system 1500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (application-specific integrated circuits, field-programmable logic devices, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1500) to perform methods in accordance with various embodiments of the invention. According to a set of embodiments, some or all of the procedures of such methods are performed by the computer system 1500 in response to processor 1510 executing one or more sequences of one or more instructions (which might be incorporated into the operating system 1540 and/or other code, such as an application program 1545) contained in the working memory 1535. Such instructions may be read into the working memory 1535 from another computer readable medium, such as one or more of the storage device(s) 1525. Merely by way of example, execution of the sequences of instructions contained in the working memory 1535 might cause the processor(s) 1510 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 1500, various computer readable media might be involved in providing instructions/code to processor(s) 1510 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical and/or magnetic disks, such as the storage device(s) 1525. Volatile media includes, without limitation, dynamic memory, such as the working memory 1535. Transmission media includes, without limitation, coaxial cables, copper wire and fiber optics, including the wires that comprise the bus 1505, as well as the various components of the communication subsystem 1530 (and/or the media by which the communications subsystem 1530 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, or any other magnetic medium, a CD-ROM, DVD, or any other optical medium, punch cards, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 1510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1500. These signals, which might be in the form of electromagnetic signals, acoustic signals, optical signals and/or the like, are all examples of carrier waves on which instructions can be encoded, in accordance with various embodiments of the invention.

The communications subsystem 1530 (and/or components thereof) generally will receive the signals, and the bus 1505 then might carry the signals (and/or the data, instructions, etc. carried by the signals) to the working memory 1535, from which the processor(s) 1505 retrieves and executes the instructions. The instructions received by the working memory 1535 may optionally be stored on a storage device 1525 either before or after execution by the processor(s) 1510.

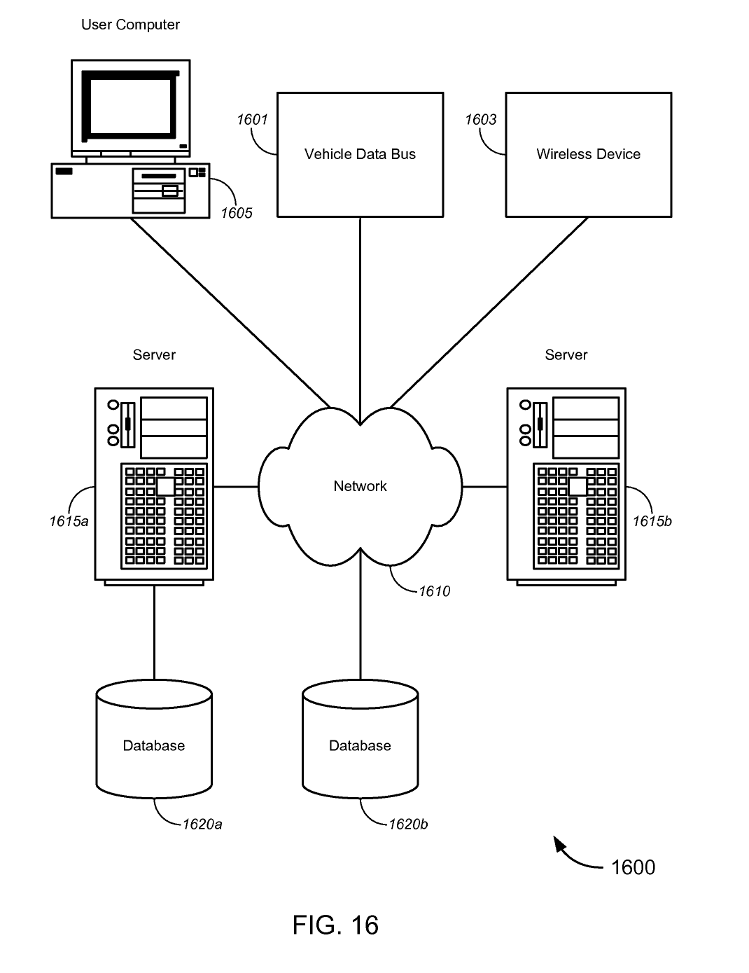

A set of embodiments comprises systems for tracking vehicle behavior, performance, and/or carbon output. Many such embodiments employ networked systems of multiple computers and/or devices. Merely by way of example, FIG. 16 illustrates a schematic diagram of a system 1600 that can be used in accordance with one set of embodiments. The system 1600 can include one or more user computers 1605. A user computer 1605 can be a general-purpose personal computers (including, merely by way of example, personal computers and/or laptop computers running any appropriate flavor of Microsoft Corp.'s Windows™ and/or Apple Corp.'s Macintosh™ operating systems) and/or a workstation computer running any of a variety of commercially available UNIX™ or UNIX-like operating systems. A user computer 1605 can also have any of a variety of applications, including one or more applications configured to perform methods provided by various embodiments (as described above, for example), as well as one or more office applications, database client and/or server applications, and/or web browser applications. Alternatively, a user computer 1605 can be any other electronic device, such as a thin-client computer, Internet-enabled mobile telephone, and/or personal digital assistant, capable of communicating via a network (e.g., the network 1610 described below) and/or displaying and navigating web pages or other types of electronic documents. Although the exemplary system 1600 is shown with three user computers 1605, any number of user computers can be supported.

Certain embodiments operate in a networked environment, which can include a network 1610. The network 1610 can be any type of network familiar to those skilled in the art that can support data communications using any of a variety of commercially-available (and/or free or proprietary) protocols, including without limitation TCP/IP, SNA, IPX, AppleTalk, and the like. Merely by way of example, the network 1610 can include a local area network (“LAN”), including without limitation an Ethernet network, a Token-Ring network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 1615. Each of the server computers 1615 may be configured with an operating system, including without limitation any of those discussed above, as well as any commercially (or freely) available server operating systems. Each of the servers 1615 may also be running one or more applications, which can be configured to provide services to one or more clients 1605 and/or other servers 1615.

Merely by way of example, one of the servers 1615 may be a web server, which can be used, merely by way of example, to process requests for web pages or other electronic documents from user computers 1605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 1605 to perform methods of the invention.

The server computers 1615, in some embodiments, might include one or more application servers, which can be configured with one or more applications accessible by a client running on one or more of the client computers 1605 and/or other servers 1615. Merely by way of example, the server(s) 1615 can be one or more general purpose computers capable of executing programs or scripts in response to the user computers 1605 and/or other servers 1615, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle™, Microsoft™, Sybase™, IBM™ the like, which can process requests from clients (including, depending on the configuration, dedicated database clients, API clients, web browsers, etc.) running on a user computer 1605 and/or another server 1615. In some embodiments, an application server can create web pages dynamically for displaying the information in accordance with various embodiments, such as for displaying reports on vehicle performance, carbon output, and/or the like. Data provided by an application server may be formatted as one or more web pages (comprising HTML, JavaScript, etc., for example) and/or may be forwarded to a user computer 1605 via a web server (as described above, for example). Similarly, a web server might receive web page requests and/or input data from a user computer 1605 and/or forward the web page requests and/or input data to an application server. In some cases a web server may be integrated with an application server.

In accordance with further embodiments, one or more servers 1615 can function as a file server and/or can include one or more of the files (e.g., application code, data files, etc.) necessary to implement various disclosed methods, incorporated by an application running on a user computer 1605 and/or another server 1615. Alternatively, as those skilled in the art will appreciate, a file server can include all necessary files, allowing such an application to be invoked remotely by a user computer 1605 and/or server 1615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 1620. The location of the database(s) 1620 is discretionary: merely by way of example, a database 1620a might reside on a storage medium local to (and/or resident in) a server 1615a (and/or a user computer 1605). Alternatively, a database 1620b can be remote from any or all of the computers 1605, 1615, so long as it can be in communication (e.g., via the network 1610) with one or more of these. In a particular set of embodiments, a database 1620 can reside in a storage-area network (“SAN”) familiar to those skilled in the art. (Likewise, any necessary files for performing the functions attributed to the computers 1605, 1615 can be stored locally on the respective computer and/or remotely, as appropriate.) In one set of embodiments, the database 1635 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method of estimating a vehicle's carbon emissions, the method comprising:
capturing, with a computer system, an identity of the vehicle;
identifying, with the computer system, a first position of the vehicle at a first time;
identifying, with the computer system, a second position of the vehicle at a second time, wherein the second time is subsequent to the first time;
ascertaining one or more operating parameters of the vehicle;
identifying a vehicle activity over a first period, based at least in part on the identified first position at the first time, the identified second position at the second time, and the one or more operating parameters of the vehicle;
estimating a carbon output rate for the first period, based at least in part on the identity of the vehicle and the vehicle activity over the first period; and
generating a carbon emission value for the vehicle, based at least in part on the first carbon output rate.

2. The method of claim 1, further comprising:
providing, to a user, feedback pertaining to the carbon emission value.

3. The method of claim 2, wherein the feedback comprises audible feedback.

4. The method of claim 3, wherein the audible feedback comprises one or more audible tones providing information about the carbon emission value.

5. The method of claim 3, wherein the audible feedback comprises voice prompts providing information about the carbon emission value.

6. The method of claim 2, wherein the feedback comprises visual feedback.

7. The method of claim 6, wherein the visual feedback comprises a numerical representation of the carbon emission value.

8. The method of claim 6, wherein the visual feedback comprises a graphical representation of the carbon emission value.

9. The method of claim 2, wherein the feedback comprises a text message.

10. The method of claim 9, wherein the text message is selected from the group consisting of a short message service (“SMS”) message, a multimedia message service (“MMS”) message, an email message, a written report, and a microblog post.

11. The method of claim 1, wherein ascertaining one or more operating parameters of the vehicle comprises receiving, from a diagnostic system of the vehicle, at least one of the one or more operating parameters of the vehicle.

12. The method of claim 1, wherein the computer system comprises a mobile device operated by a user of the vehicle.

13. The method of claim 12, wherein the mobile device is a handheld wireless device.

14. The method of claim 12, wherein the mobile device is mounted in the vehicle.

15. The method of claim 12, wherein the mobile device is incorporated within the vehicle.

16. The method of claim 12, wherein identifying a vehicle activity comprises:
transmitting, from the mobile device, data about the first position of the vehicle at the first time and the second position of the vehicle at a second time;
receiving the data at a server computer; and
analyzing the data at the server computer to identify an activity of the vehicle.

17. The method of claim 12, wherein estimating a carbon output rate for the first period comprises estimating the carbon output rate at a server computer in communication with the mobile device.

18. The method of claim 12, wherein generating a carbon emission value for the vehicle comprises generating a carbon emission value at a server computer in communication with the mobile handheld device, the method further comprises:
transmitting, from the server computer, information about the carbon emission value for the vehicle; and
receiving, at the mobile device, the information about the carbon emission value for the vehicle.

19. The method of claim 1, wherein capturing an identity of the vehicle comprises receiving, at the computer system, user input identifying the vehicle.

20. The method of claim 1, wherein capturing an identity of the vehicle comprises discovering a vehicle identification number (“VIN”) of the vehicle.

21. The method of claim 20, wherein discovering a VIN of the vehicle comprises receiving the VIN from a vehicle diagnostic system in the vehicle.

22. The method of claim 1, wherein generating a carbon emission value for the vehicle comprises comparing the carbon output rate for the first period with a baseline carbon output rate for the vehicle activity.

23. The method of claim 1, wherein estimating a carbon output rate comprises identifying an estimated carbon output rate based on the identified vehicle activity and an identification of the vehicle.

24. The method of claim 1, further comprising:
identifying values of one or more vehicle performance statistics for the vehicle, based at least in part on the identity of the vehicle;
wherein estimating a carbon output rate comprises deriving a carbon output rate based on the identified values of the one or more vehicle performance statistics.

25. The method of claim 24, wherein the one or more vehicle performance statistics comprise one or more parameters selected from the group consisting of: fuel consumed per unit of distance driven, average speed, change in altitude, engine speed, and an operating gear level of a transmission of the vehicle,

26. The method of claim 24, wherein identifying values of one or more vehicle performance statistics comprises receiving a value of at least one operating parameter from a vehicle data system in the vehicle.

27. The method of claim 24, wherein identifying values of one or more vehicle performance statistic comprises obtaining an estimated value of at least one vehicle performance statistic from a database, based at least in part on an identification of the vehicle.

28. The method of claim 27, wherein the database comprises a plurality of data sets, each of the plurality of data sets comprising a plurality of estimated vehicle performance statistic values for a different make and model of vehicle.

29. The method of claim 27, wherein the database is managed by a server computer remote from the vehicle.

30. The method of claim 1, wherein identifying the first position of the vehicle comprises receiving, from a global navigation satellite system (“GNSS”) receiver, position information about the vehicle at the first time.

31. The method of claim 1, wherein identifying the first position of the vehicle comprises triangulating the first position of the vehicle based on wireless signals received from multiple wireless transmitters.

32. The method of claim 1, wherein the identified first position comprises a first altitude of the vehicle, and wherein the identified second position comprises a second altitude of the vehicle.

33. The method of claim 1, further comprising:
identifying a third position of the vehicle at a third time;
determining that the vehicle has changed activities, based at least in part on the identified third position of the vehicle at the third time;
identifying a second vehicle activity over a second period, based at least in part on the identified second position at the second time and the identified third position at the third time; and
estimating a second carbon output rate for the second period;
wherein generating a carbon emission value for the vehicle comprises generating a carbon emission value for the vehicle, based at least in part on the first carbon output rate and the second carbon output rate.

34. The method of claim 1, further comprising:
generating a report on the carbon emission value, the report comprising information about the carbon output rate for the first period; and
providing the report to a user.

35. The method of claim 34, wherein providing a report to the user comprises providing the report to the user via electronic mail.

36. The method of claim 34, wherein providing a report to the user comprises providing the report to the user via a web site.

37. The method of claim 34, wherein the report comprises a comparison of the carbon emission value with a baseline value.

38. The method of claim 34, further comprising:
formatting the report in a format required by a carbon credit trading exchange.

39. The method of claim 34, further comprising:
generating a plurality of carbon emission values for the vehicle over a specified interval of time;
wherein generating a report on the carbon emission value comprises generating a report on the plurality of carbon emission values.

40. The method of claim 34, further comprising:
generating a plurality of carbon emission values for a plurality of vehicles used by the user;
wherein generating a report on the carbon emission value comprises generating a report on the plurality of carbon emission values.

41. The method of claim 34, wherein the vehicle is part of a fleet of vehicles, the method, and wherein the user is selected from the group consisting of an operator of the vehicle, a fleet manager of the fleet of vehicles, and an owner of the fleet of vehicles.

42. The method of claim 1, wherein the vehicle is a first vehicle within a fleet comprising a plurality of vehicles, the method further comprising:
generating carbon emission values for each of the plurality of vehicles.

43. The method of claim 42, further comprising:
generating a report comprising information about the carbon emission value for each of the plurality of vehicles.

44. The method of claim 43, wherein each of the plurality of vehicles have a common make and model, and wherein the report comprises a comparison between the carbon emission value for the first vehicle and one or more carbon emission values for one or more other vehicles in the plurality of vehicles.

45. The method of claim 42, further comprising:
providing, from a second computer system, a user interface for a fleet manager to view carbon emission values for each of the plurality of vehicles.

46. The method of claim 1, wherein the vehicle is a first construction vehicle, the method further comprising:
generating carbon emission values for a plurality of construction vehicles, the plurality of construction vehicles comprising the first construction vehicle and one or more additional construction vehicles.

47. An apparatus for estimating a vehicle's carbon emissions, comprising:
a computer readable medium having encoded thereon a set of instructions executable by one or more computers to perform one or more operations, the set of instructions comprising:
instructions for capturing, with a computer system, an identity of the vehicle;
instructions for identifying, with the computer system, a first position of the vehicle at a first time;
instructions for identifying, with the computer system, a second position of the vehicle at a second time, wherein the second time is subsequent to the first time;
instructions for ascertaining one or more operating parameters of the vehicle;
instructions for identifying a vehicle activity over a first period, based at least in part on the identified first position at the first time, the identified second position at the second time, and the one or more operating parameters of the vehicle;
instructions for estimating a carbon output rate for the first period, based at least in part on the identity of the vehicle and the vehicle activity over the first period; and
instructions for generating a carbon emission value for the vehicle, based at least in part on the first carbon output rate.

48. A system, comprising:
a computer system comprising one or more processors; and
a computer readable medium in communication with the one or more processors, the computer readable medium having encoded thereon a set of instructions executable by the computer system to perform one or more operations, the set on instructions comprising:
instructions for capturing, with the computer system, an identity of a vehicle;
instructions for identifying, with the computer system, a first position of the vehicle at a first time;
instructions for identifying, with the computer system, a second position of the vehicle at a second time, wherein the second time is subsequent to the first time;
instructions for ascertaining one or more operating parameters of the vehicle;
instructions for identifying a vehicle activity over a first period, based at least in part on the identified first position at the first time, the identified second position at the second time, and the one or more operating parameters of the vehicle;
instructions for estimating a carbon output rate for the first period, based at least in part on the identity of the vehicle and the vehicle activity over the first period; and
instructions for generating a carbon emission value for the vehicle, based at least in part on the first carbon output rate.

49. The system of claim 48, wherein the computer system comprises a mobile device.

50. The system of claim 49, wherein the mobile device is a handheld wireless device.

51. The system of claim 49, wherein the mobile device is mounted in the vehicle.

52. The system of claim 49, wherein the mobile device is incorporated within the vehicle.

53. The system of claim 48, wherein the computer system is a tracking server remote from the vehicle, the system further comprising:
a mobile device associated with the vehicle.

54. The system of claim 53, wherein the set of instructions further comprises:
instructions for receiving, from the mobile device, at least some of the one or more operating parameters.

55. The system of claim 53, wherein the mobile device has stored thereon a mobile tracking application comprising a second of instructions executable by the mobile device, the second set of instructions comprising:
instructions for collecting the at least some of the one or more operating parameters; and
instructions for transmitting the at least some of the one or more operating parameters for reception by the tracking server.

56. The system of claim 55, wherein the second set of instructions further comprises:
instructions for providing a user interface to allow interaction between the user and the tracking server.

57. The system of claim 55, wherein the set of instructions at the server computer further comprises:
instructions for transmitting, from the server computer, information about the carbon emission value for the vehicle, to be received by the mobile device.

58. The system of claim 48, further comprising:
a position determination system configured to determine positions of the vehicle system at associated times.

59. The system of claim 48, wherein the set of instructions further comprises:
instructions for providing, to a user, feedback pertaining to the carbon emission value.

60. The system of claim 59, wherein the feedback comprises audible feedback.

61. The system of claim 60, wherein the audible feedback comprises one or more audible tones providing information about the carbon emission value.

62. The system of claim 60, wherein the audible feedback comprises voice prompts providing information about the carbon emission value.

63. The system of claim 59, wherein the feedback comprises visual feedback.

64. The system of claim 63, wherein the visual feedback comprises a numerical representation of the carbon emission value.

65. The system of claim 63, wherein the visual feedback comprises a graphical representation of the carbon emission value.

66. The system of claim 59, wherein the feedback comprises a text message.

67. The system of claim 66, wherein the text message is selected from the group consisting of a short message service (“SMS”) message, a multimedia message service (“MMS”) message, an email message, a written report, and a microblog post.

68. The system of claim 48, wherein the instructions for ascertaining one or more operating parameters of the vehicle comprise instructions for receiving, from a diagnostic system of the vehicle, at least one of the one or more operating parameters of the vehicle.

69. The system of claim 48, wherein the instructions for capturing an identity of the vehicle comprises instructions for receiving user input identifying the vehicle.

70. The system of claim 48, wherein the instructions for capturing an identity of the vehicle comprise instructions for discovering a vehicle identification number (“VIN”) of the vehicle.

71. The system of claim 70, wherein the instructions for discovering a VIN of the vehicle comprise instructions for receiving the VIN from a vehicle diagnostic system in the vehicle.

72. The system of claim 48, wherein the instructions for generating a carbon emission value for the vehicle comprise instructions for comparing the carbon output rate for the first period with a baseline carbon output rate for the vehicle activity.

73. The system of claim 48, wherein the instructions for estimating a carbon output rate comprise instructions for identifying an estimated carbon output rate based on the identified vehicle activity and an identification of the vehicle.

74. The system of claim 48, wherein the set of instructions further comprises:
instructions for identifying values of one or more vehicle performance statistics for the vehicle, based at least in part on the identity of the vehicle;
wherein the instructions for estimating a carbon output rate comprise instructions for deriving a carbon output rate based on the identified values of the one or more vehicle performance statistics.

75. The system of claim 74, wherein the one or more vehicle performance statistics comprise one or more parameters selected from the group consisting of: fuel consumed per unit of distance driven, average speed, change in altitude, engine speed, and an operating gear level of a transmission of the vehicle,

76. The system of claim 74, wherein the instructions for identifying values of one or more vehicle performance statistics comprise instructions for receiving a value of at least one operating parameter from a vehicle data system in the vehicle.

77. The system of claim 74, wherein the instructions for identifying values of one or more vehicle performance statistic comprise instructions for obtaining an estimated value of at least one vehicle performance statistic from a database, based at least in part on an identification of the vehicle.

78. The system of claim 77, wherein the database comprises a plurality of data sets, each of the plurality of data sets comprising a plurality of estimated vehicle performance statistic values for a different make and model of vehicle.

79. The system of claim 77, wherein the database is managed by a server computer remote from the vehicle.

80. The system of claim 48, wherein the instructions for identifying the first position of the vehicle comprise instructions for receiving, from a global navigation satellite system (“GNSS”) receiver, position information about the vehicle at the first time.

81. The system of claim 48, wherein the instructions for identifying the first position of the vehicle comprise instructions for triangulating the first position of the vehicle based on wireless signals received from multiple wireless transmitters.

82. The system of claim 48, wherein the identified first position comprises a first altitude of the vehicle, and wherein the identified second position comprises a second altitude of the vehicle.

83. The system of claim 48, wherein the set of instructions further comprises:
instructions for identifying a third position of the vehicle at a third time;
instructions for determining that the vehicle has changed activities, based at least in part on the identified third position of the vehicle at the third time;
instructions for identifying a second vehicle activity over a second period, based at least in part on the identified second position at the second time and the identified third position at the third time; and
instructions for estimating a second carbon output rate for the second period;
wherein the instructions for generating a carbon emission value for the vehicle comprise instructions for generating a carbon emission value for the vehicle, based at least in part on the first carbon output rate and the second carbon output rate.

84. The system of claim 48, wherein the set of instructions further comprises:
instructions for generating a report on the carbon emission value, the report comprising information about the carbon output rate for the first period; and
instructions for providing the report to a user.

85. The system of claim 84, wherein the instruction for providing the report to a user comprise instructions for providing the report to the user via electronic mail.

86. The system of claim 84, wherein the instruction for providing the report to a user comprise instructions for providing the report to the user via a web site.

87. The system of claim 84, wherein the report comprises a comparison of the carbon emission value with a baseline value.

88. The system of claim 84, wherein the set of instructions further comprises:
instructions for formatting the report in a format required by a carbon credit trading exchange.

89. The system of claim 84, wherein the set of instructions further comprises:
instructions for generating a plurality of carbon emission values for the vehicle over a specified interval of time;
wherein the instructions for generating a report on the carbon emission value comprise instructions for generating a report on the plurality of carbon emission values.

90. The system of claim 84, wherein the set of instructions further comprises:
instructions for generating a plurality of carbon emission values for a plurality of vehicles used by the user;
wherein the instructions for generating a report on the carbon emission value comprise instructions for generating a report on the plurality of carbon emission values.

91. The system of claim 84, wherein the vehicle is part of a fleet of vehicles, and wherein the user is selected from the group consisting of an operator of the vehicle, a fleet manager of the fleet of vehicles, and an owner of the fleet of vehicles.

92. The system of claim 48, wherein the vehicle is a first vehicle within a fleet comprising a plurality of vehicles, and wherein the set of instructions further comprises:
instructions for generating carbon emission values for each of the plurality of vehicles.

93. The system of claim 92, wherein the set of instructions further comprises:
instructions for generating a report comprising information about the carbon emission value for each of the plurality of vehicles.

94. The system of claim 93, wherein each of the plurality of vehicles have a common make and model, and wherein the report comprises a comparison between the carbon emission value for the first vehicle and one or more carbon emission values for one or more other vehicles in the plurality of vehicles.

95. The system of claim 92, wherein the set of instructions further comprises:
instructions for providing a user interface for a fleet manager to view carbon emission values for each of the plurality of vehicles.

96. The system of claim 48, wherein the vehicle is a first construction vehicle, and wherein the set of instructions further comprises:
instructions for generating carbon emission values for a plurality of construction vehicles, the plurality of construction vehicles comprising the first construction vehicle and one or more additional vehicles.

97. A method of estimating carbon emissions for a fleet of vehicles, the method comprising:
for each of a plurality of vehicles in the fleet of vehicles:
capturing, with a computer system, an identity of the vehicle;
identifying a vehicle activity over a first period;
estimating a carbon output rate for the first period, based at least in part on the identity of the vehicle and the vehicle activity over the first period; and
generating a carbon emission value for the vehicle, based at least in part on the first carbon output rate; and
consolidating the carbon emission values generated for each of the plurality of vehicles, to obtain a carbon emission value for the fleet of vehicles.

98. The method of claim 97, further comprising:
calculating an amount of a carbon credit corresponding to the carbon emission value for the fleet of vehicles.

99. The method of claim 98, further comprising:
distributing the carbon credit among one or more entities.

100. The method of claim 99, wherein distributing the carbon credit comprises charging a fee in conjunction with distributing the carbon credit.

101. The method of claim 100, wherein the fee comprises a portion of the carbon credit.

102. The method of claim 97, further comprising:
establishing a baseline carbon emission value for at least one of the vehicles;
comparing a first vehicle's carbon emission value with the baseline carbon emission value; and
evaluating a performance of an operator of the first vehicle based on a comparison of the first vehicle's carbon emission value with the baseline carbon emission value.

103. The method of claim 97, further comprising:
comparing a first carbon emission value for a first vehicle with a second carbon emission value for a second vehicle; and
evaluating a performance of a first operator of the first vehicle against a performance of a second operator of the second vehicle, based on a comparison of the first carbon emission value with the second carbon emission value.

104. The method of claim 97, wherein the fleet of vehicles comprises a corporate fleet of vehicles.

105. The method of claim 97, wherein the fleet of vehicles comprises a plurality of vehicles each having different owners.

106. The method of claim 105, wherein each of the plurality of owners shares a common demographic characteristic.

107. The method of claim 97, wherein the fleet of vehicles is a fleet of construction vehicles, and wherein the plurality of vehicles comprises a plurality of construction vehicles.

108. The method of claim 107, wherein the plurality of construction vehicles comprises a first set of construction vehicles associated with a first construction project, the first set of construction vehicles comprising the first construction vehicle, the method further comprising:
generating a first project carbon emission value for the first project, based at least in part on the carbon emission values for each of the construction vehicles in the first set of construction vehicles.

109. The method of claim 108, wherein the first project carbon emission value is a sum of each of the carbon emission values for the first set of construction vehicles.

110. The method of claim 108, wherein the first project carbon emission value is an average of each of the carbon emission values for the first set of construction vehicles.

111. The method of claim 108, further comprising:
generating a project carbon emission report comprising information about the first project carbon emission value.

112. The method of claim 111, wherein generating a project carbon emission report comprises formatting the project carbon emission report to comply with a set of reporting requirements imposed by a governing body.

113. The method of claim 108, further comprising:
comparing the first project carbon emission value with a target project emission value; and
providing feedback to a user indicating a relationship between the first project carbon emission value and the target project carbon emission value.

114. The method of claim 108, wherein the plurality of construction vehicles further comprises a second set of construction vehicles associated with a second construction project, the method further comprising:
generating a second project carbon emission value for the second project, based at least in part on the carbon emission values for each of the construction vehicles in the second set of construction vehicles.

115. The method of claim 114, further comprising:
comparing the first project carbon emission value and the second project carbon emission value with one or more target project carbon emission values;
determining that one of the project carbon emission values exceeds a target project emission value with which that project carbon emission value has been compared; and
identifying a reallocation scheme for the first set of vehicles and the second set of vehicles, wherein the reallocation scheme ensures that the first project carbon emission value does not exceed any target project emission value with which the first project carbon emission value has been compared and that the second project carbon emission value does not exceed any target project emission value with which the second project carbon emission value has been compared; and
providing output to a user describing one or more vehicles to be reallocated between the first set of vehicles and the second set of vehicles, based on the identified reallocation scheme.

116. An apparatus, comprising:
a computer readable medium having encoded thereon a set of instructions executable by one or more computers to perform one or more operations, the set of instructions comprising:
for each of a plurality of vehicles in the fleet of construction vehicles:
instructions for capturing, with a computer system, an identity of the vehicle;
instructions for identifying a vehicle activity over a first period;
instructions for estimating a carbon output rate for the first period, based at least in part on the identity of the vehicle and the vehicle activity over the first period; and
instructions for generating a carbon emission value for the vehicle, based at least in part on the first carbon output rate; and
instructions for consolidating the carbon emission values generated for each of the plurality of vehicles, to obtain a carbon emission value for the fleet of construction vehicles.

117. A computer system, comprising:
one or more processors; and
a computer readable medium in communication with the one or more processors, the computer readable medium having encoded thereon a set of instructions executable by the computer system to perform one or more operations, the set on instructions comprising:
for each of a plurality of vehicles in the fleet of construction vehicles:
instructions for capturing, with a computer system, an identity of the vehicle;
instructions for identifying a vehicle activity over a first period;
instructions for estimating a carbon output rate for the first period, based at least in part on the identity of the vehicle and the vehicle activity over the first period; and
instructions for generating a carbon emission value for the vehicle, based at least in part on the first carbon output rate; and
instructions for consolidating the carbon emission values generated for each of the plurality of vehicles, to obtain a carbon emission value for the fleet of construction vehicles.

118. The computer system of claim 117, wherein the set of instructions further comprises:
instructions for establishing a baseline carbon emission value for at least one of the vehicles;
instructions for comparing a first vehicle's carbon emission value with the baseline carbon emission value; and
instructions for evaluating a performance of an operator of the first vehicle based on a comparison of the first vehicle's carbon emission value with the baseline carbon emission value.

119. The computer system of claim 117, wherein the set of instructions further comprises:
instructions for comparing a first carbon emission value for a first vehicle with a second carbon emission value for a second vehicle; and
instructions for evaluating a performance of a first operator of the first vehicle against a performance of a second operator of the second vehicle, based on a comparison of the first carbon emission value with the second carbon emission value.

120. The computer system of claim 117, wherein the plurality of construction vehicles comprises a first set of construction vehicles associated with a first construction project, the first set of construction vehicles comprising the first construction vehicle, and wherein the set of instructions further comprises:
instructions for generating a first project carbon emission value for the first project, based at least in part on the carbon emission values for each of the construction vehicles in the first set of construction vehicles.

121. The computer system of claim 120, wherein the first project carbon emission value is a sum of each of the carbon emission values for the first set of construction vehicles.

122. The computer system of claim 120, wherein the first project carbon emission value is an average of each of the carbon emission values for the first set of construction vehicles.

123. The computer system of claim 120, further comprising:
generating a project carbon emission report comprising information about the first project carbon emission value.

124. The computer system of claim 123, wherein generating a project carbon emission report comprises formatting the project carbon emission report to comply with a set of reporting requirements imposed by a governing body.

125. The computer system of claim 120, wherein the set of instructions further comprises:
instructions for comparing the first project carbon emission value with a target project emission value; and
instructions for providing feedback to a user indicating a relationship between the first project carbon emission value and the target project carbon emission value.

126. The computer system of claim 120, wherein the plurality of construction vehicles further comprises a second set of construction vehicles associated with a second construction project, and wherein the set of instructions further comprises:
instructions for generating a second project carbon emission value for the second project, based at least in part on the carbon emission values for each of the construction vehicles in the second set of construction vehicles.

127. The computer system of claim 126, wherein the set of instructions further comprises:
instructions for comparing the first project carbon emission value and the second project carbon emission value with one or more target project carbon emission values;
instructions for determining that one of the project carbon emission values exceeds a target project emission value with which that project carbon emission value has been compared;
instructions for identifying a reallocation scheme for the first set of vehicles and the second set of vehicles, wherein the reallocation scheme ensures that the first project carbon emission value does not exceed any target project emission value with which the first project carbon emission value has been compared and that the second project carbon emission value does not exceed any target project emission value with which the second project carbon emission value has been compared; and
instructions for providing output to a user describing one or more vehicles to be reallocated between the first set of vehicles and the second set of vehicles, based on the identified reallocation scheme.

128. A mobile device for providing information to a user about carbon emissions, the mobile device comprising:
one or more processors;
a first interface, in communication with the one or more processors, for receiving position information;
a second interface, in communication with the one or more processors, for communicating via a communication network; and
a computer readable storage medium in communication with the one or more processors, the computer readable storage medium having encoded thereon a set of instructions executable by the mobile device to perform one or more operations, the set of instructions comprising:
instructions for providing a user interface to allow interaction between a user and the mobile device;
instructions for identifying a vehicle for which carbon output is to be tracked;
instructions for receiving position information via the first interface;
instructions for identifying, based at least in part on the position information, a first position of the mobile device at a first time;
instructions for identifying, based at least in part on the position information, a second position of the mobile device at a second time;
instructions for transmitting, via the second interface, an identification of the vehicle, an identification of the first position and an identification of the second position;
instructions for receiving, via the second interface, information about carbon emissions of the vehicle over a period of time defined by the first time and the second time; and
instructions for providing, via the user interface, feedback for the user, based on the information about carbon emissions of the vehicle over the period of time.

129. The mobile device of claim 128, wherein the set of instructions are incorporated by an application that is provided for distribution on a plurality of mobile devices without fee.

130. The mobile device of claim 128, wherein the first interface comprises a global network satellite system receiver.

131. The mobile device of claim 128, wherein the first interface comprises a communication interface for communicating with a separate device comprising a global network satellite system receiver.

132. The mobile device of claim 128, wherein the first interface comprises a communication interface for receiving radio signals from which a position of the mobile device can be triangulated.

133. The mobile device of claim 128, wherein the second interface comprises a wireless interface comprising one or more radios.

134. The mobile device of claim 128, wherein the one or more radios are selected from the group consisting of a cellular radio and a WiFi radio.

135. An apparatus, comprising:
a computer readable storage medium having encoded thereon a set of instructions executable by a mobile device to perform one or more operations, the set of instructions comprising:
instructions for providing a user interface to allow interaction between a user and the mobile device;
instructions for identifying a vehicle for which carbon output is to be tracked;
instructions for receiving position information at the mobile device;
instructions for identifying, based at least in part on the position information, a first position of the mobile device at a first time;
instructions for identifying, based at least in part on the position information, a second position of the mobile device at a second time;
instructions for transmitting an identification of the vehicle, an identification of the first position and an identification of the second position;
instructions for receiving information about carbon emissions of the vehicle over a period of time defined by the first time and the second time; and
instructions for providing, via the user interface, feedback for the user, based on the information about carbon emissions of the vehicle over the period of time.
